(19) United States
(12) Patent Application Publication
(10) Pub. No.: US 2015/0361318 A1
(43) Pub. Date: Dec. 17, 2015

(54) COMPOSITE POLYMER MATERIALS FOR MODIFICATION OF ADHESIVE COMPOSITIONS AND ASSOCIATED METHODS OF MANUFACTURE

(71) Applicant: MeadWestvaco Corporation, Richmond, VA (US)

(72) Inventors: Everett CREWS, Charleston, SC (US); Tejash GANDHI, Daniel Island, SC (US); Peter SCHILLING, Charleston, SC (US); Stefan SCHILLING, Mount Pleasant, SC (US); James E. Wurst, North Charleston, SC (US); Roger K. CHATTERJEE, Charleston, SC (US)

(21) Appl. No.: 14/740,561

(22) Filed: Jun. 16, 2015

Related U.S. Application Data
(60) Provisional application No. 62/012,973, filed on Jun. 16, 2014.

(51) Int. Cl. C09J 195/00; C09J 109/06; C08L 17/00; C08L 93/04; C09J 117/00; C08L 9/06

(52) U.S. Cl. CPC C09J 195/00; C09J 117/00; C08L 9/06; C08L 17/00; C08L 93/04; C09J 109/06

(57) ABSTRACT

The present description provides composite polymer compositions comprising a plastomeric material, an elastomeric material or a combination thereof, and an additive, for example, a dispersant or surface active agent (i.e., surfactant). The description also provides methods of manufacturing and using the same, e.g., to improve or modify the performance of adhesive materials, such as, for example, asphalt.

### REFERENCE TO RELATED APPLICATION

This application claims the benefit of priority under 35 U.S.C. §119(e) of U.S. provisional application Ser. No. 62/012,973 filed on Jun. 17, 2014, which is hereby incorporated by reference in its entirety.

### FIELD OF THE INVENTION

The description provides composite polymeric compositions comprising a plastomer and/or an elastomer, and an additive, e.g., a dispersant or surfactant, and associated methods of manufacturing and use. The composite polymeric compositions are useful for modifying and improving the performance characteristics of adhesives, e.g., bitumens or asphalt.

### BACKGROUND

To improve or modify the performance characteristics of industrial adhesives, e.g., bonding, flow, wear and temperature durability, etc. modifying agents, such as polymers, can be added. For example, polymeric materials can be added to laminating adhesives or epoxy resins, such as those used in making countertops or flooring, and bitumens (or asphalt) in order to modify and enhance their performance characteristics. However, a common problem exists in the art that such polymeric modifiers tend to separate from the liquid or semi-solid phase. The loss of homogeneous dispersion undermines the effectiveness of the polymeric modifiers.

For example, asphalt is used for a variety of purposes, including use in asphalt concrete road paving and coating systems, and in roofing materials. Asphalt road pavement and roofing materials may be exposed to a wide variety of weather conditions, including temperatures from below freezing to well over 100° F. At colder temperatures, asphalt can become brittle and crack, while at higher temperatures, asphalt can permanently deform, for example by rutting in road pavements. Therefore, modifications that extend or improve the properties of asphalt in cold or hot conditions are desirable. In addition, the availability of asphalt materials has been reduced in recent years, which has resulted in a concomitant increase in cost of these materials. For these and other reasons, there is great interest in finding ways to extend the useful life of asphalt containing products.

Asphalt blended with crumb rubber, e.g., ground rubber, ground recycled rubber, ground tire rubber (GTR) or recycled tire rubber (RTR) (collectively, “crumb rubber”), has been used extensively and has been previously described. In general, the addition of crumb rubber to asphalt allows for improved performance of roads or other paved surfaces due to resistance to rutting, cracking and deformation. Furthermore, the addition of ground tire rubber can reduce road noise. Not only does crumb rubber improve the performance of the asphalt, it allows old tires to be recycled into a useful substance instead of piling up in tire dumps. However, known methods of blending crumb rubber with asphalt or bitumen typically lead to a heterogeneous blend with the solid, rubber phase, settling out from the liquid, adhesive phase, when agitation is stopped. As a result, the crumb rubber is not sufficiently distributed or dispersed within the asphalt composition, thus requiring continuous agitation. The solid material is primarily carbon black, which has a significant negative impact on the workability of the crumb rubber modified asphalt. The solid material mainly affects the viscosity and storage stability of the crumb rubber-modified asphalt.

As a result of these drawbacks, the use of crumb rubber in asphalt has been limited to some specific processes requiring special equipment. This can significantly increase the cost of pavement produced using the crumb rubber modified asphalt. Thus, an ongoing need exists in the art for materials that can enhance the performance of adhesives, e.g., asphalt or bitumen, but that remain dispersed in the liquid phase for longer periods without the necessity of constant agitation and/or the use of specialized equipment.

### SUMMARY

The description provides composite polymer compositions comprising a plastomeric material, an elastomeric material or a combination thereof, and an additive, for example, a dispersant or surface active agent (i.e., surfactant). The description also provides methods of manufacturing and using the same, e.g., to improve or modify the performance of adhesive materials, such as, for example, asphalt. Surprisingly and unexpectedly, it was found that the composite polymer compositions as described herein demonstrate improved dispersion characteristics in adhesive media, such as asphalt or bitumen, such that settling of the polymeric and/or rubber material is reduced or eliminated, and the duration that the material remains homogeneously dispersed in the liquid phase is increased. The composite polymers as described herein also provide for control over the degree of dispersion over a range of dispersed states from particulate to sol (or colloid) to gel. As such, the description also provides formulations comprising a composite polymer as described herein, and an adhesive media, and methods of preparing the same.

Therefore, in a first aspect the description provides a composite polymer composition comprising a plastomeric and/or elastomeric substance or material, and an additive including a dispersant or surfactant. In certain embodiments, the composite polymeric material comprises a plastomer, an elastomer or a combination of both. In certain embodiments, the composite polymer material comprises from about 20% to about 95% by weight of a plastomer material, elastomer material or combination of both. In certain embodiments, the polymer comprises about 20%, 25%, 30%, 35%, 40%, 45%, 50%, 55%, 60%, 65%, 70%, 75%, 80%, 85%, 90%, or 95% by weight of a plastomer, elastomer or combination thereof. In certain embodiments, the plastomer or elastomer is a substituted or unsubstituted alkene or olefin, diene or diolefin, polyene, alkyne, substituted or unsubstituted polyethylene or oxidized polyethylene, polyethylene terephthalate (PET), styrene, polystyrene, crumb rubber (new or used, synthetic or vulcanized), e.g., styrene-butadiene, or styrene-butadiene-styrene (SBS), styrene-isoprene-styrene (SIS), neoprene, nitrile, recycled rubber such as GTR or RTR, or a combination thereof, and including homopolymers or copolymers of the same. In still additional embodiments, the plastomer or elastomer is cross-linked.

In certain embodiments the plastomeric material, elastomeric material or combination thereof are dispersed in the additive, e.g., a dispersant or surfactant by, e.g., mixing and/or heating, and the mixture is formed into a pellet, granule, powder, or flake. In additional embodiments, the plastomeric material, elastomeric material or combination of both are coated with an additive, e.g., a dispersant or surfactant, and formed into a pellet, granule, powder or flake.

In any of the composite polymer embodiments described herein, the composite polymer may comprise from about 0.01% to about 80% by weight of an additive, including, e.g., a dispersant and/or surfactant or mixture comprising a dispersant and/or surfactant. In certain embodiments, the composite polymer comprises about 0.01%, 0.1%, 1%, 5%, 10%, 15%, 20%, 25%, 30%, 35%, 40%, 45%, 50%, 55%, 60%, 65%, 70%, 75%, or 80% by weight of an additive, e.g., a dispersant and/or surfactant or mixture comprising a dispersant and/or surfactant.

In any of the compositions or methods described herein, the dispersant or surfactant of the composite polymer composition may be any known dispersant or surfactant (e.g., anionic, cationic, zwitterionic, nonionic, biosurfactant, etc.) with the caveat that the dispersant or surfactant is able to improve the dispersion of the polymeric or rubber material in an adhesive medium. In certain embodiments, the dispersant or surfactant is at least one of an amide derivative of a C6-C22 fatty acid, an amidated tall oil, fatty acid amide, tall oil fatty acid amide, fatty acid amide of morpholine, fatty acid amide of dimethyl amine, fortified tall oil fatty acid amide, tall oily fatty acid amindoamine or the like, e.g., polyethylene polyamine derivatives of TOFA or other fatty acid, lipid, phospholipic, e.g., phosphotidylcholine or lecithin, or a combination thereof. Significantly, the inclusion of a sufficient amount of a surfactant provides for the control of the degree of dispersion of the plastomer and/or elastomer material, e.g., a polymer and/or recycled rubber. As such, in certain embodiments, the description provides a composite polymer comprising a plastomeric material, an elastomeric material or combination thereof and a sufficient amount of a dispersant or surfactant to modify or enhance the dispersion characteristics of the material in a liquid adhesive medium, e.g., asphalt.

In still an additional embodiment, the description provides a composite polymer composition consisting essentially of or consisting of a plastomeric material, an elastomeric material or combination thereof, and an additive comprising a sufficient amount of a dispersant or surfactant to modify or enhance the dispersion characteristics of the material in a liquid adhesive medium, e.g., asphalt.

In any of the composite polymeric material embodiments described herein, the polymeric material may further comprise from about 0.01% to about 80% by weight of at least one of tall oil, tall oil fatty acid (TOFA), distilled tall oil, TOFA derivative, ester of TOFA, methyl ester, alkyl ester, glycerol ester, penterythritol ester or combination thereof. In certain embodiments, the composite polymer comprises about 0.01%, 0.1%, 1%, 5%, 10%, 15%, 20%, 25%, 30%, 35%, 40%, 45%, 50%, 55%, 60%, 65%, 70%, 75%, or 80% by weight of at least one of tall oil, tall oil fatty acid (TOFA), distilled tall oil, TOFA derivative, ester of TOFA, methyl ester, alkyl ester, glycerol ester, penterythritoal ester or combination thereof.

In any of the composite polymeric material embodiments described herein, the polymeric material may further comprise from about 0% to about 80% by weight of a rheology enhancer, e.g., a tall oil derivative, such as rosin, gum rosin, rosin acid, rosin derivatives, rosin oil, rosin esters, glycerol esters, penterythritol esters, esters of fortified rosin acid (i.e., rosin acid reacted with maleic anhydride or fumaric acid or acrylic acid). In certain embodiments, the composite polymer comprises about 0%, 0.001%, 0.01%, 0.1%, 1%, 5%, 10%, 15%, 20%, 25%, 30%, 35%, 40%, 45%, 50%, 55%, 60%, 65%, 70%, 75%, or 80% by weight of a rheology enhancer.

In any of the composite polymeric material embodiments described herein, the polymeric material may futher comprise at least one of a natural fat or oil, e.g., a fixed oil such as a vegetable oil, such as, soybean oil, tarrow oil, rapeseed oil, rice bran oil, trigclyceride, lipid, or an essential oil. In certain embodiments, the composite polymer comprises about 0%, 0.001%, 0.01%, 0.1%, 1%, 5%, 10%, 15%, 20%, 25%, 30%, 35%, 40%, 45%, 50%, 55%, 60%, 65%, 70%, 75%, or 80% by weight of at least one of a natural fat or oil, e.g., a fixed oil such as a vegetable oil, such as, soybean oil, tarrow oil, rapeseed oil, rice bran oil, trigclyceride, lipid, or an essential oil.

In another aspect, the description provides a modified adhesive formulation comprising an adhesive, and a composite polymer composition as described herein, wherein, the composite polymer composition comprises an additive comprising a sufficient amount of dispersant or surfactant to prevent, delay or reduce phase separation in the adhesive (i.e., “an effective amount”) as compared to a polymeric or rubber that lacks a dispersant or surfactant as described herein. In certain embodiments, the composite polymer material includes a sufficient amount of surfactant to improve or prolong dipersion (i.e., prevent or reduce settling) of the polymeric material in the adhesive medium for at least 6, 12, 18, 24, 36, 48, 60, or 72 hours following agitation. In certain embodiments, the adhesive is asphalt or bitumen. In certain additional embodiments, the adhesive is a laminating adhesive, e.g., an epoxy. In certain embodiments, the modified adhesive formulation comprises at least about 80%, 85%, 90%, 95%, or more by weight of an adhesive, and from about 0.1% to about 20% by weight of a composite polymer material as described herein. In a preferred embodiment, the adhesive is asphalt, and the resulting modified adhesive formulation is an asphalt-paving formulation.

As described herein, the degree of dispersion of the composite polymer composition in the adhesive media can be “tuned” over a range of dispersed states from particulate to sol (colloid) to gel.

In another aspect, the description provides methods of making a composite polymeric material as described herein.

In another aspect, the description provides methods of making a composite polymer material as described herein. In an embodiment, the method comprises the steps of: a) admixing and dispersing at least one of an elastomer, a plastomer or a combination thereof in an additive, e.g., including a surfactant, with heat; b) mixing the composition from (a) with crumb rubber forming a homogenized mixture, wherein the additive acts as a glue to hold together the elastomer and/or plastomer, and wherein the dispersed elastomer and/or plastomer mixture forms a dough; c) shaping the dough from (b) into smaller pellets while still warm; and d) cooling the pellets from (c).

In still another aspect, the description provides methods of making a modified adhesive formulation comprising admixing a composite polymeric material as described herein, and an adhesive material, e.g., asphalt or a laminating adhesive. In a preferred embodiment, the description provides a method of making a modified asphalt formulation comprising admixing asphalt and an effective amount of a composite polymeric material as described herein, wherein the composite polymeric material prevents or delays the phase separation of the asphalt from the composite polymer material.

The preceding general areas of utility are given by way of example only and are not intended to be limiting on the scope of the present disclosure and appended claims. Additional objects and advantages associated with the compositions, methods, and processes of the present invention will be appreciated by one of ordinary skill in the art in light of the instant claims, description, and examples. For example, the various aspects and embodiments of the invention may be utilized in numerous combinations, all of which are expressly contemplated by the present description. These additional advantages, objects and embodiments are expressly included within the scope of the present invention. The publications and other materials used herein to illuminate the background of the invention, and in particular cases, to provide additional details respecting the practice, are incorporated by reference.

### BRIEF DESCRIPTION OF THE DRAWINGS

The accompanying drawings, which are incorporated into and form a part of the specification, illustrate several embodiments of the present invention and, together with the description, serve to explain the principles of the invention. The drawings are only for the purpose of illustrating an embodiment of the invention and are not to be construed as limiting the invention. Further objects, features and advantages of the invention will become apparent from the following detailed description taken in conjunction with the accompanying figures showing illustrative embodiments of the invention, in which:

FIG. 1 depicts certain embodiments as described herein. FIG. 1 highlights formulation ingredients, processing and conversion operations, and end-use applications encompassed by the present description. In particular, the table exemplifies formulation ingredients and processing operations related to adhesives applications involving bituminous paving compositions for road construction and road maintenance.

FIG. 2 is an illustration of one aspect of the present invention. The figure illustrates dispersion states of polymeric material possible according to the compositions and methods as described herein. In particular, the figure depicts particulate, sol, and gel dispersion states.

FIG. 3 is an illustration of one aspect of the present invention. That is, it shows that the polymeric material may be treated with surfactants and additives taught in the present invention prior to introduction of the surfactant-treated polymeric material to the adhesive medium.

FIG. 4 depicts exemplary formulation variables and process conditions, which are described herein. The formulation and manufacturing process can be varied in a number of ways which are encompassed by the present description.

FIG. 5 provides experimental viscosity results for a number of exemplary formulations as described herein.

FIG. 6 shows surfactant-mediated control of the degree of dispersion of the polymeric material so that the polymeric materials in the finished adhesive composition exist in a controlled degree of dispersion ranging from particulate to sol to gel.

FIG. 7 shows the results from measurement of the degree of transformation of solid, recycled tire rubber elastomer from particulate matter to a sol-gel state dispersed in bitumen using compositions and methods as described herein.

FIG. 8 shows examples of values for B, P, and S using many different additives at a dosage of 1.0% by weight of the bitumen.

### DETAILED DESCRIPTION

The following is a detailed description provided to aid those skilled in the art in practicing the present invention. Those of ordinary skill in the art may make modifications and variations in the embodiments described herein without departing from the spirit or scope of the present disclosure. All publications, patent applications, patents, figures and other references mentioned herein are expressly incorporated by reference in their entirety.

Presently described are compositions and methods that relate to the surprising and unexpected discovery that composite polymer compositions as described herein demonstrate improved dispersion characteristics in adhesive media, such as asphalt or bitumens, such that settling of the polymeric material is reduced or eliminated, and the duration that the material remains homogeneously dispersed in the liquid phase is increased. The composite polymers as described herein also provide for control over the degree of dispersion over a range of dispersed states from particulate to sol (or colloid) to gel. As such, the description also provides formulations comprising a composite polymer as described herein, and an adhesive media, and methods of preparing the same.

In certain aspects, the description provides composite polymer compositions comprising a plastomeric material, and/or an elastomeric substance or material, and an additive, including, e.g., a dispersant or surface active agent (i.e., surfactant); methods of manufacturing and using the same, e.g., to improve the performance of adhesive materials. Significantly, while the composite polymer materials improve the dispersion characteristics in an adhesive medium, other physical properties, which impart the desired field performance of the adhesive (e.g., asphalt or bitumen) preparation, are maintained or not lost. For example, the composite polymers as described herein also improve performance of roads or other paved surfaces in terms of, e.g., resistance to cracking, rutting, and deformation; and improved moisture resistance, and noise reduction.

### DEFINITIONS

Unless otherwise defined, all technical and scientific terms used herein have the same meaning as commonly understood by one of ordinary skill in the art to which this invention belongs. The terminology used in the description is for describing particular embodiments only and is not intended to be limiting of the invention.

Where a range of values is provided, it is understood that each intervening value, to the tenth of the unit of the lower limit unless the context clearly dictates otherwise (such as in the case of a group containing a number of carbon atoms in which case each carbon atom number falling within the range is provided), between the upper and lower limit of that range and any other stated or intervening value in that stated range is encompassed within the invention. The upper and lower limits of these smaller ranges may independently be included in the smaller ranges is also encompassed within the invention, subject to any specifically excluded limit in the stated range. Where the stated range includes one or both of the limits, ranges excluding either both of those included limits are also included in the invention.

The following terms are used to describe the present invention. In instances where a term is not specifically defined herein, that term is given an art-recognized meaning by those of ordinary skill applying that term in context to its use in describing the present invention.

The articles “a” and “an” as used herein and in the appended claims are used herein to refer to one or to more than one (i.e., to at least one) of the grammatical object of the article unless the context clearly indicates otherwise. By way of example, “an element” means one element or more than one element.

The phrase “and/or,” as used herein in the specification and in the claims, should be understood to mean “either or both” of the elements so conjoined, i.e., elements that are conjunctively present in some cases and disjunctively present in other cases. Multiple elements listed with “and/or” should be construed in the same fashion, i.e., “one or more” of the elements so conjoined. Other elements may optionally be present other than the elements specifically identified by the “and/or” clause, whether related or unrelated to those elements specifically identified. Thus, as a non-limiting example, a reference to “A and/or B”, when used in conjunction with open-ended language such as “comprising” can refer, in one embodiment, to A only (optionally including elements other than B); in another embodiment, to B only (optionally including elements other than A); in yet another embodiment, to both A and B (optionally including other elements); etc.

As used herein in the specification and in the claims, “or” should be understood to have the same meaning as “and/or” as defined above. For example, when separating items in a list, “or” or “and/or” shall be interpreted as being inclusive, i.e., the inclusion of at least one, but also including more than one, of a number or list of elements, and, optionally, additional unlisted items. Only terms clearly indicated to the contrary, such as “only one of” or “exactly one of,” or, when used in the claims, “consisting of,” will refer to the inclusion of exactly one element of a number or list of elements. In general, the term “or” as used herein shall only be interpreted as indicating exclusive alternatives (i.e., “one or the other but not both”) when preceded by terms of exclusivity, such as “either,” “one of,” “only one of,” or “exactly one of”.

In the claims, as well as in the specification above, all transitional phrases such as “comprising,” “including,” “carrying,” “having,” “containing,” “involving,” “holding,” “composed of,” and the like are to be understood to be open-ended, i.e., to mean including but not limited to. Only the transitional phrases “consisting of” and “consisting essentially of” shall be closed or semi-closed transitional phrases, respectively, as set forth in the United States Patent Office Manual of Patent Examining Procedures, Section 2111.03.

As used herein in the specification and in the claims, the phrase “at least one,” in reference to a list of one or more elements, should be understood to mean at least one element selected from anyone or more of the elements in the list of elements, but not necessarily including at least one of each and every element specifically listed within the list of elements and not excluding any combinations of elements in the list of elements. This definition also allows that elements may optionally be present other than the elements specifically identified within the list of elements to which the phrase “at least one” refers, whether related or unrelated to those elements specifically identified. Thus, as a nonlimiting example, “at least one of A and B” (or, equivalently, “at least one of A or B,” or, equivalently “at least one of A and/or B”) can refer, in one embodiment, to at least one, optionally including more than one, A, with no B present (and optionally including elements other than B); in another embodiment, to at least one, optionally including more than one, B, with no A present (and optionally including elements other than A); in yet another embodiment, to at least one, optionally including more than one, A, and at least one, optionally including more than one, B (and optionally including other elements); etc.

It should also be understood that, in certain methods described herein that include more than one step or act, the order of the steps or acts of the method is not necessarily limited to the order in which the steps or acts of the method are recited unless the context indicates otherwise.

The term “compound”, as used herein, unless otherwise indicated, refers to any specific chemical compound disclosed herein and includes tautomers, regioisomers, geometric isomers, and where applicable, stereoisomers, including optical isomers (enantiomers) and other stereoisomers (diastereomers) thereof, as well as salts and derivatives thereof where applicable, in context. Within its use in context, the term compound generally refers to a single compound, but also may include other compounds such as stereoisomers, regioisomers and/or optical isomers (including racemic mixtures) as well as specific enantiomers or enantiomerically enriched mixtures of disclosed compounds. It is noted that in describing the present compounds, numerous substituents and variables associated with same, among others, are described. It is understood by those of ordinary skill that molecules which are described herein are stable compounds as generally described hereunder.

The term “independently” is used herein to indicate that the variable, which is independently applied, varies independently from application to application.

The term “alkylene” when used, refers to a —(CH2)n- group (n is an integer generally from 0-6), which may be optionally substituted. When substituted, the alkylene group preferably is substituted on one or more of the methylene groups with a C1-C24 alkyl group (including a cyclopropyl group or a t-butyl group), but may also be substituted with one or more halo groups, preferably from 1 to 3 halo groups or one or two hydroxyl groups, O—(C1-C24 alkyl) groups or amino acid sidechains as otherwise disclosed herein. In certain embodiments, an alkylene group may be substituted with a urethane or alkoxy group (or other group) which is further substituted with a polyethylene glycol chain (of from 1 to 24, preferably 1 to 10, often 1 to 4 ethylene glycol units) to which is substituted (preferably, but not exclusively on the distal end of the polyethylene glycol chain) an alkyl chain substituted with a single halogen group, preferably a chlorine group.

The term “Alkynyl” refers to linear, branch-chained or cyclichydrocarbon radicals containing at least one C≡C bond.

The term “Heterocycle” refers to a cyclic group which contains at least one heteroatom, e.g., N, O or S, and may be aromatic (heteroaryl) or non-aromatic. Thus, the heteroaryl moieties are subsumed under the definition of heterocycle, depending on the context of its use. Exemplary heteroaryl groups are described hereinabove. Exemplary heterocyclics include: azetidinyl, benzimidazolyl, 1,4-benzodioxanyl, 1,3-benzodioxolyl, benzoxazolyl, benzothiazolyl, benzothienyl, dihydroimidazolyl, dihydropyranyl, dihydrofuranyl, dioxanyl, dioxolanyl, ethyleneurea, 1,3-dioxolane, 1,3-dioxane, 1,4-dioxane, furyl, homopiperidinyl, imidazolyl, imidazolinyl, imidazolidinyl, indolinyl, indolyl, isoquinolinyl, isothiazolidinyl, isothiazolyl, isoxazolidinyl, isoxazolyl, morpholinyl, naphthyridinyl, oxazolidinyl, oxazolyl, pyridone, 2-pyrrolidone, pyridine, piperazinyl, N-methylpiperazinyl, piperidinyl, phthalimide, succinimide, pyrazinyl, pyrazolinyl, pyridyl, pyrimidinyl, pyrrolidinyl, pyrrolinyl, pyrrolyl, quinolinyl, tetrahydrofuranyl, tetrahydropyranyl, tetrahydroquinoline, thiazolidinyl, thiazolyl, thienyl, tetrahydrothiophene, oxane, oxetanyl, oxathiolanyl, thiane among others.

Heterocyclic groups can be optionally substituted with a member selected from the group consisting of alkoxy, substituted alkoxy, cycloalkyl, substituted cycloalkyl, cycloalkenyl, substituted cycloalkenyl, acyl, acylamino, acyloxy, amino, substituted amino, aminoacyl, aminoacyloxy, oxyaminoacyl, azido, cyano, halogen, hydroxyl, keto, thioketo, carboxy, carboxyalkyl, thioaryloxy, thioheteroaryloxy, thioheterocyclooxy, thiol, thioalkoxy, substituted thioalkoxy, aryl, aryloxy, heteroaryl, heteroaryloxy, heterocyclic, heterocyclooxy, hydroxyamino, alkoxyamino, nitro, —SO— alkyl, —SO-substituted alkyl, —SOaryl, —SO-heteroaryl, —SO2-alkyl, —SO2-substituted alkyl, SO2-aryl, oxo (═O), and —SO2-heteroaryl. Such heterocyclic groups can have a single ring or multiple condensed rings. Examples of nitrogen heterocycles and heteroaryls include, but are not limited to, pyrrole, imidazole, pyrazole, pyridine, pyrazine, pyrimidine, pyridazine, indolizine, isoindole, indole, indazole, purine, quinolizine, isoquinoline, quinoline, phthalazine, naphthylpyridine, quinoxaline, quinazoline, cinnoline, pteridine, carbazole, carboline, phenanthridine, acridine, phenanthroline, isothiazole, phenazine, isoxazole, phenoxazine, phenothiazine, imidazolidine, imidazoline, piperidine, piperazine, indoline, morpholino, piperidinyl, tetrahydrofuranyl, and the like as well as N-alkoxy-nitrogen containing heterocycles. The term “heterocyclic” also includes bicyclic groups in which any of the heterocyclic rings is fused to a benzene ring or a cyclohexane ring or another heterocyclic ring (for example, indolyl, quinolyl, isoquinolyl, tetrahydroquinolyl, and the like).

The term “cycloalkyl” can mean but is in no way limited to univalent groups derived from monocyclic or polycyclic alkyl groups or cycloalkanes, as defined herein, e.g., saturated monocyclic hydrocarbon groups having from three to twenty carbon atoms in the ring, including, but not limited to, cyclopropyl, cyclobutyl, cyclopentyl, cyclohexyl, cycloheptyl and the like. The term “substituted cycloalkyl” can mean but is in no way limited to a monocyclic or polycyclic alkyl group and being substituted by one or more substituents, for example, amino, halogen, alkyl, substituted alkyl, carbyloxy, carbylmercapto, aryl, nitro, mercapto or sulfo, whereas these generic substituent groups have meanings which are identical with definitions of the corresponding groups as defined in this legend.

“Heterocycloalkyl” refers to a monocyclic or polycyclic alkyl group in which at least one ring carbon atom of its cyclic structure being replaced with a heteroatom selected from the group consisting of N, O, S or P. “Substituted heterocycloalkyl” refers to a monocyclic or polycyclic alkyl group in which at least one ring carbon atom of its cyclic structure being replaced with a heteroatom selected from the group consisting of N, O, S or P and the group is containing one or more substituents selected from the group consisting of halogen, alkyl, substituted alkyl, carbyloxy, carbylmercapto, aryl, nitro, mercapto or sulfo, whereas these generic substituent group have meanings which are identical with definitions of the corresponding groups as defined in this legend.

The term “unsubstituted” shall mean substituted only with hydrogen atoms. The term “substituted” or “optionally substituted” shall mean independently (i.e., where more than substituent occurs, each substituent is independent of another substituent) one or more substituents (independently up to five substitutents, preferably up to three substituents, often 1 or 2 substituents on a moiety in a compound according to the present invention and may include substituents which themselves may be further substituted) at a carbon (or nitrogen) position anywhere on a molecule within context, and includes as substituents hydroxyl, thiol, carboxyl, cyano (C≡N), nitro (NO2), halogen (preferably, 1, 2 or 3 halogens, especially on an alkyl, especially a methyl group such as a trifluoromethyl), an alkyl group, aryl (especially phenyl and substituted phenyl for example benzyl or benzoyl), alkoxy group, thioether, acyl, ester or thioester including alkylene ester, hydrazine, amido, alkanol, or alkanoic acid.

The term “asphalt” is used herein can mean but is not limited to any suitable naturally-occurring asphalt or asphalt cement, synthetically manufactured asphalt or asphalt cement, such as any asphalt that is a by-product of a petroleum refining process, blown asphalt, blended asphalt, residual asphalt, aged asphalt, petroleum asphalt, straight-run asphalt, thermal asphalt, paving grade-asphalt, performance graded asphalt cement, asphalt flux, bitumen, or the like. Suitable performance graded asphalt cements include, for example, any asphalt cements having the following characteristics set forth in ASTM D6373-99

The term “rubber,” as used herein, can mean but is not limited to any material made substantially of rubber, such as, for example, virgin rubber, recycled rubber (such as from tires, inner-tubes, gaskets, rubber scrap, or the like), peel rubber, cured rubber, and/or processed rubber of any polymer type(s), such as, for example, tire rubber (e.g., scrap tire rubber, whole tire solid rubber, and/or scrap whole tire rubber), non-solvent-treated rubber, non-pre-swelled rubber, and/or any rubber that comprises less than about 5% (such as less than about 3% or even 1%) of talc powder, such as wherein the rubber has no insoluble materials such as metals, fibers, cords, wood, rocks, dirt, and/or the like.

The term “granules,” as used herein, can mean but is not limited to any suitable form of rubber for use in preparing a rubber-modified asphalt cement, such as particles, crumbs, and/or other particulate forms (e.g., shavings or flakes, fines, beads, or the like), which can be produced and/or processed in any manner (such as via vulcanization, ambient grinding and/or cryogenic grinding). Moreover, granules can exist in suitable size prior to formation of the rubber-modified asphalt cement, such that, for example, greater than about 80%, 85%, or 90% by weight (such as greater than about 95%, or even greater than about 99% by weight) of the rubber granules, relative to the total weight of the rubber granules, have a size of less than about 20 mesh (such as less than about 25 mesh, less than about 30 mesh, less than about 35 mesh, less than about 40 mesh, less than about 45 mesh, less than about 50 mesh, less than about 60 mesh, less than about 70 mesh, or even less than about 80 mesh) in accordance with U.S. Sieve series.

As used herein, surface active agents or surfactants can mean but is not limited to surface active substances or materials that lower the surface tension of a liquid (e.g., water, oil or other hydrophobic medium). More specifically, surface active agents include but are not limited to substances falling within classes of cationic, anionic, zwitterionic, amphoteric, and nonionic surfactants. In certain aspects, the composite polymer composition as described herein comprises a surface active agent having an amphophilic structure containing both an oleophilic chemical moiety and a hydrophilic chemical moiety. The oleophilic chemical moiety is characterized by a basic hydrocarbon structure of an aliphatic chain, branched or linear, saturated or unsaturated, possibly substituted with heteroatoms other than carbon, and having an overall length dimension of 10 to 24 covalently bonded carbon atoms. The 10 to 24 covalently bonded carbon atoms form what is known as an oleophilic tail group to those skilled in surface chemistry. The hydrophilic moiety is characterized by the presence of atoms and chemical functional groups having polarizable or ionizable electronic orbitals or bonds. Such hydrophilic functional groups typically abound in oxygen and nitrogen atoms.

As used herein, the term “cationic surface active agents” includes fatty acid and fatty acid derivatives such as amides, amidoamines, polyamides, polyamidoamines, imides and imidazolines and their polyamino analogs. Cationic surfactants also include fatty alkyl amines, fatty alkyl trimethylene polyamines and the like.

As used herein, the term “improved cationic surface active agents” can mean but is not limited to amine-based or amide-based surface active agents, e.g., fatty acid amides derived from heterocyclic amide functionality such as morpholine, pyrrolidine, piperazine, C6-C22 amides derived from dialkyl amines such as dimethyl amine, diethyl amine, dipropyl amine, and higher homologs, and derivatives thereof. The amides as taught herein are produced at ambient pressures using conventional amide synthesis from fatty acid or fatty acid ester precursors.

As used herein, the term “anionic surface active agents” can mean but is not limited to alkali, alkali earth, and other metal salts of fatty acids and fatty acid derivatives. Examples of members of this class include sodium and potassium carboxylates. Organic salts of fatty acids and fatty acid derivatives, such as alkylammonium carboxylates, are also included. Other anionic surface active agents include alkyl sulfates, sulfonates, phosphates, phosphonates, and the like.

As used herein, the term “amphoteric surface active agent” or “zwitterionic surface active agent” include chemical structures contain both a cationic and an anionic functional moiety. Examples of members of this class include alkyl betaines (like cocobetaine), sulfo betaines, phosphoryl amines (like lecithin), and the like.

As used herein, the term “nonionic surface active agents” can mean but is not limited to surfactant compounds that do not have a charged, hydrophilic head group species. Alkyloxylated (e.g., ethoxylated and/or propoxylated) long chain (C6-C22) alcohols are common examples of this class of agent, as are the surface active products of reaction of initially cationic and anionic surfactants with ethylene oxide, oxiranes, and other alkyloxylation reagents.

In any of the embodiments described herein, the surface active agents taught in this invention may be used singly or in conjunction with other members of the same or different surface active agent classes.

As used herein, the term “elastomer” or “elastomeric” can mean but is not limited to substances such as polystyrene, polystyrene-butadiene-styrene block di- and ter-polymers, polystyrene-butadiene rubber, recycled tire rubber (from automobiles, trucks, and sporting goods such as tennis balls), and combinations thereof. Elastomeric materials disclosed herein may vary in physical dimensions, ranging for example from 1000 micron to submicron size. Elastomeric materials may be unused or recycled materials (again as exemplified by recycled tires). Mixtures of elastomeric materials are suitable for use according to the teachings of this invention.

Generally, synthetic rubbers are produced from monomers obtained from the cracking and refining of petroleum. Suitable monomers for the production of synthetic rubbers include, but are not limited to, styrene, butadiene, carboxylated butadiene, isobutylene, isoprene, carboxylated isoprene, chloroprene, ethylene, propylene, acrylonitrile, and mixtures thereof.

In one embodiment, the elastomer is a block copolymer of at least one conjugated diene and at least one monoalkenyl aromatic hydrocarbon. The preferred conjugated dienes are butadiene, isoprene, chloroprene, carboyxlated butadiene, and carboxylated isoprene. Most preferably, the conjugated diene is butadiene and isoprene. The preferred monoalkyenyl aromatic hydrocarbon is styrene. Such block copoly mers can have a general formula A-B-A or (A*B)n X

Wherein each A block is a monoalkyenyl aromatic hydrocarbon polymer block, each B block is a conjugated diolefin polymer block, X is a coupling agent and n is an integer from 2 to about 30. Such block copolymers can be linear or may have a radial or star configuration as well as being tapered.

As used herein, the term “plastomers” can mean but is not limited to polymeric materials such as polyethylene, polyisobutylene, polyesters, polyamides, urethanes, polymers of acrylic acid derivatives, and blends thereof. Plastomeric materials disclosed herein may vary in physical dimensions, ranging for example from 1000 micron to submicron size. Plastomeric materials may be unused or recycled plastics. In certain embodiments, the plastomer is a polyethylene homopolymer. Exemplary commercially available plastomers that are suitable for use in the compositions and methods described herein include those from Eastman Chemical Company, BASF (e.g., Petra™ PET, Ultramide™ polyamide thermoplastic), Dow (e.g., Affinity™ polyolefins and Amplify™ maleated polyolefins) Celanese (Impact™ PET), and Repsol (Ethylene vinyl acetate), to name a few. Mixtures of plastomeric and elastomeric materials are also suitable for use according to the teachings of this invention, as are polymeric materials with a blend of plastomeric and elastomeric properties.

As used herein, the term “crumb rubber” can mean but is not limited to processed and comminuted new or used (i.e., recycled) rubber, e.g., ground tire rubber (GTR) or recycled tire rubber (RTR). RTR is processed in two main ways, ambient temperature (conditions) attrition and comminution using a variety of chopping, cutting, and shreading industrial-scale equipment. RTR is also produced via cryogenic processes, wherein the tire material is rendered into a highly brittle, friable state by freezing to very low temperatures. The embrittled, frozen rubber can be fractured easily in crushing operations.

Composite Polymers

Typically, asphalt is either modified using, e.g., SBS alone or RTR alone. However, recently SBS, which is relatively expensive, is being replaced by more economical alternatives, such as, for example, RTR. Some asphalt producers have tried this with varying degrees of success. Some of the problems with substituting SBS with RTR are poor storage stability of the asphalt (the RTR particles tend to settle in asphalt), and handling RTR in large quantities at asphalt plants (RTR is a dry powder and very fine material could be a potential hazard).

Thus, the production of the isolable composite polymer material as described herein enables several significant advantages, including 1) elimination of the problems of handling potentially-flammable, dry powdered RTR in industrial facilities; 2) production of modified bitumen that has greater resistance to settlement than conventionally modified SBS- or RTR-modified bitumen; and 3) manufacturing throughput can be increased because the composite polymer material as described herein is more readily dispersed in bitumen.

Significantly, the description provides composite polymeric compositions including an elastomeric material and/or a plastomeric material, and a surfactant, which provides control over the state of dispersion of plastomeric and elastomeric substances and materials in an adhesive media. This description further pertains to formulations comprising a mixture of surfactants, polymeric substances and materials, and adhesive media. In certain aspects, the description relates to combining the composite polymer materials to yield adhesive compositions wherein the degree of dispersion of the polymeric substances and materials is controlled over a range of dispersed states from particulate to sol to gel.

This description also pertains to processes wherein all or a portion of the polymeric materials and surfactants are brought together to produce an isolable solid or liquid intermediate that may be, in a subsequent unit operation, brought together with the adhesive medium to yield a finished adhesive composition. The isolable intermediate, which comprises all or a portion of the polymeric materials and surfactant to be included in the finished adhesive composition, is also formulated and produced in such a manner that the degree of surfactant-induced dispersion of the polymeric substances and materials is controlled over a range of dispersed states from particulate to sol to gel. Thus, the description pertains also to the production of these isolable intermediates that are, because of their controlled state of dispersion, more efficiently dispersed or solubilized in the adhesive medium to form the final adhesive composition.

This disclosure also pertains to formulations of surface active agents, polymeric substances and materials, and adhesive media and processes for bringing these formulation ingredients into contact in a manner wherein the rheological properties of the final adhesive composition are controlled from particulate to sol (colloid) to gel. Thus, the combination of surfactant-mediated dispersion and rheological control disclosed in the present invention yields finished adhesive compositions, which are resistant to alterations (like settlement and creaming) due solely to the forces of gravity. The properties of the finished asphalt compositions pertaining to the present invention are influenced only to forces of thermal (Brownian) motion and shear.

In a particular embodiment, the disclosure relates to the production of compositions of the polymeric elastomers and plastomers, e.g., recycled tire rubber, and surface active agents in the form of powders, granules, pastilles, extrudates, and block masses of varying physical dimension, which are subsequently combined with the adhesive medium to form the finished adhesive composition. Thus, this disclosure also provides finished adhesive compositions comprising bitumen including a composite polymer comprising polymeric plastomers and/or elastomers, e.g., recycled tire rubber, surface active agents that impart dispersion and rheological control. These specific, novel bitumen-based adhesive compositions, characterized by uniquely controlled dispersion and rheological properties, are intended for use applications to which bitumen is commonly applied. These applications include chiefly water impermeabilization, roof and pavement maintainance, and roof and pavement rehabilitation and construction.

Therefore, in a first aspect the description provides a composite polymer composition comprising a plastomeric and/or elastomeric substance or material, and an additive including a dispersant or surfactant. In certain embodiments, the composite polymeric material comprises a plastomer, an elastomer or a combination of both. In certain embodiments, the composite polymer material comprises from about 20% to about 95% by weight of a plastomer material, elastomer material or combination of both. In certain embodiments, the polymer comprises about 20%, 25%, 30%, 35%, 40%, 45%, 50%, 55%, 60%, 65%, 70%, 75%, 80%, 85%, 90%, or 95% by weight of a plastomer, elastomer or combination thereof. In certain embodiments, the plastomer or elastomer is a substituted or unsubstituted alkene or olefin, diene or diolefin, polyene, alkyne, substituted or unsubstituted polyethylene or oxidized polyethylene, polyethylene terephthalate (PET), ethylene vinyl acetate (EVA), styrene, polystyrene, crumb rubber (new or used, synthetic or vulcanized), e.g., styrene-butadiene, or styrene-butadiene-styrene (SBS), styrene-isoprene-styrene (SIS), neoprene, nitrile, recycled rubber such as GTR or RTR, or a combination thereof, and including homopolymers or copolymers of the same. In still additional embodiments, the plastomer or elastomer is cross-linked.

In any of the composite polymer embodiments described herein, the composite polymer may comprise from about 0.01% to about 80% by weight of an additive, including, e.g., a dispersant or surfactant or mixture comprising a dispersant or surfactant. In certain embodiments, the composite polymer comprises about 0.01%, 0.1%, 1%, 5%, 10%, 15%, 20%, 25%, 30%, 35%, 40%, 45%, 50%, 55%, 60%, 65%, 70%, 75%, or 80% by weight of an additive, e.g., a dispersant or surfactant or mixture comprising a dispersant or surfactant.

In any of the compositions or methods described herein, the dispersant or surfactant of the composite polymer composition may be any known dispersant or surfactant (e.g., anionic, cationic, zwitterionic, nonionic, biosurfactant, etc.) with the caveat that the dispersant or surfactant is able to improve the dispersion of the polymeric or rubber material in an adhesive medium. In certain embodiments, the dispersant or surfactant is at least one of an amide derivative of a C6-C22 fatty acid, an amidated tall oil, fatty acid amide, tall oil fatty acid amide, fatty acid amide of morpholine, fatty acid amide of dimethyl amine, fortified tall oil fatty acid amide, tall oily fatty acid amindoamine or the like, e.g., polyethylene polyamine derivatives of TOFA or other fatty acid, polyalkylene polyamines, including alkylene polyamines like propyl diamine, butyl diamine, hexamethylene diamine (adipyl diamine), bis-hexamethylene triamine, tris-hexamethylene tetramine, lipid, phospholipic, e.g., phosphotidylcholine or lecithin, or a combination thereof.

For example, in certain embodiments, the amine-based surfactant has the structure:

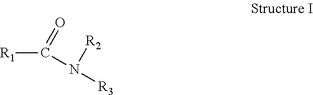

Wherein the functional group R₁ may be a saturated or unsaturated, linear, branched, or cyclic, substituted or unsubstituted hydrocarbon functional group of C-6 to C-22 carbon atoms, such as those found in linear and branched fatty acids, rosin acids and other terpene and diterpene acids, naphthenic acids, and aromatic acids; and the functional group R₂ and R₃ are independently selected from saturated or unsaturated hydrocarbon moieties (of 1-18 carbon atoms) of a linear or branched structure and containing heterocyclic atom substitutions, a cyclic group (e.g., aryl, or heterocyclic) having saturated or unsaturated hydrocarbon units substituted or unsubstituted with heterocyclic functionality. In certain embodiments, R₂ and R₃ are independently selected from morpholine, piperidine, and pyrrolidine analogs and derivatives thereof.

In certain embodiments, Structure 1 may be bis-amides, tris-amides, or higher polyamides derived from reaction of dimer, trimer, and higher-order polymerized C6-C22 fatty acids and C20 rosin acid analogs and derivatives. Such structures would be exemplified by commercial products such as the dimerized (C-36) and trimerized (C-54) tall oil fatty acids, MWV DTC 155 and MWV DTC 195.

In additional embodiments, Structure 1 also may be bis-amides, tris-amides, and higher polyamides derived from reaction with di-carboxylic acid fatty acid derivatives formed by reactions such as the Diels-Alder and/or ene reaction of unsaturated fatty acid with dieneophiles such as acrylic acid, acrylic acid esters, and derivatives thereof, fumaric acid, fumaric acid esters, and derivatives thereof. An, examples of these types of products include MWV DIACID 1550.

In certain embodiments, wherein Structure 1 is tall oil dimethyl amide (TDMA), R₁ is a combination of an oleic acid and linoleic acid chain, and R₂=R₃=a methyl group, CH₃ (below).

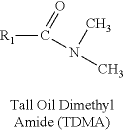

In certain embodiments, wherein Structure 1 is a morpholine amide of tall oil (8986-55D), then R₁ is a combination of an oleic acid and linoleic acid chain, R2 and R3 constitute a tetramethylene chain (below).

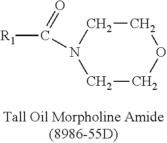

Significantly, the inclusion of a sufficient amount of a surfactant provides for the control of the degree of dispersion of the plastomer and/or elastomer material, e.g., a polymer and/or recycled rubber. As such, in certain embodiments, the description provides a composite polymer comprising a plastomeric material, an elastomeric material or combination thereof and a sufficient amount of a dispersant or surfactant to modify or enhance the dispersion characteristics of the material in a liquid adhesive medium, e.g., asphalt.

In certain embodiments, the composite polymer composition comprises SBS, crumb rubber, and a surfactant, wherein the surfactant is present at a sufficient amount of improve or enhance the dispersion characteristics (i.e., reduction phase separation, increased duration of dispersion, etc.) of the polymer material in an adhesive relative to a polymer lacking the surfactant. In certain embodiments, the surfactant is at least one of an amide derivative of a C6-C22 fatty acid, an amidated tall oil, fatty acid amide, tall oil fatty acid amide, fatty acid amide of morpholine, fatty acid amide of dimethyl amine, fortified tall oil fatty acid amide, tall oily fatty acid amindoamine or the like, e.g., polyethylene polyamine derivatives of TOFA or other fatty acid, lipid, phospholipic, e.g., phosphotidylcholine or lecithin, or a combination thereof.

In still an additional embodiment, the description provides a composite polymer composition consisting essentially of or consisting of a plastomeric material, and/or an elastomeric material, such as SBS, RTR or a combination thereof, and an additive comprising a sufficient amount of a dispersant or surfactant to modify or enhance the dispersion characteristics of the material in a liquid adhesive medium, e.g., asphalt, wherein the surfactant is selected from the group consisting of tall oil fatty acid amide, fatty acid amide of morpholine, fatty acid amide of dimethyl amine, fortified tall oil fatty acid amide, tall oily fatty acid amindoamine.

In any of the composite polymeric material embodiments described herein, the polymeric material may further comprise from about 0.01% to about 80% by weight of at least one of tall oil, tall oil fatty acid (TOFA), distilled tall oil, or TOFA derivative, esters of TOFA, methyl ester, alkyl ester, glycerol ester, penterythritol ester or combinations thereof. In certain embodiments, the composite polymer comprises about 0.01%, 0.1%, 1%, 5%, 10%, 15%, 20%, 25%, 30%, 35%, 40%, 45%, 50%, 55%, 60%, 65%, 70%, 75%, or 80% by weight of at least one of tall oil, tall oil fatty acid (TOFA), distilled tall oil, or TOFA derivative, esters of TOFA, methyl ester, alkyl ester, glycerol ester, penterythritol ester or combinations thereof.

In any of the composite polymeric material embodiments described herein, the polymeric material may further comprise from about 0% to about 80% by weight of a rheology enhancer, e.g., a tall oil derivative, such as rosin, gum rosin, rosin acid, rosin derivatives, rosin oil, rosin esters, glycerol esters, penterythritol esters, esters of fortified rosin acid (i.e., rosin acid reacted with maleic anhydride or fumaric acid or acrylic acid). In certain embodiments, the composite polymer comprises about 0%, 0.001%, 0.01%, 0.1%, 1%, 5%, 10%, 15%, 20%, 25%, 30%, 35%, 40%, 45%, 50%, 55%, 60%, 65%, 70%, 75%, or 80% by weight of a rheology enhancer.

In any of the composite polymeric material embodiments described herein, the polymeric material may futher comprise at least one natural fat or oil, e.g., a fixed oil such as a vegetable oil, such as, soybean oil, tarrow oil, rapeseed oil, rice bran oil, trigclyceride, lipid, or an essential oil. In certain embodiments, the composite polymer comprises about 0%, 0.001%, 0.01%, 0.1%, 1%, 5%, 10%, 15%, 20%, 25%, 30%, 35%, 40%, 45%, 50%, 55%, 60%, 65%, 70%, 75%, or 80% by weight of at least one natural fat or oil, e.g., a fixed oil such as a vegetable oil, such as, soybean oil, tarrow oil, rapeseed oil, rice bran oil, trigclyceride, lipid, or an essential oil.

In another aspect, the description provides a modified adhesive formulation comprising an adhesive, and a composite polymer composition as described herein, wherein, the composite polymer composition comprises an additive comprising a sufficient amount of dispersant or surfactant to prevent, delay or reduce phase separation in the adhesive (i.e., “an effective amount”) as compared to a polymeric or rubber that lacks a dispersant or surfactant as described herein. In certain embodiments, the composite polymer material includes a sufficient amount of surfactant to improve or prolong dipersion (i.e., prevent or reduce settling) of the polymeric material in the adhesive medium for at least 6, 12, 18, 24, 36, 48, 60, or 72 hours following agitation. In certain embodiments, the adhesive is asphalt or bitumen. In certain additional embodiments, the adhesive is a laminating adhesive, e.g., an epoxy. In certain embodiments, the modified adhesive formulation comprises at least about 80%, 85%, 90%, 95%, or more by weight of an adhesive, and from about 0.1% to about 20% by weight of a composite polymer material as described herein. In a preferred embodiment, the adhesive is asphalt, and the resulting modified adhesive formulation is an asphalt-paving formulation.

In certain embodiments the plastomeric material, elastomeric material or combination thereof are dispersed in the additive, e.g., a dispersant or surfactant by, e.g., mixing and/or heating, and the mixture is formed into a pellet, granule, powder, or flake. In additional embodiments, the plastomeric material, elastomeric material or combination of both are coated with an additive, e.g., a dispersant or surfactant, and formed into a pellet, flake, powder, granule, pastille, extrudate, and/or block mass of any suitable physical dimension, which can be subsequently combined with the adhesive medium to form the finished adhesive composition.

Examples in the present invention involve bitumen as the adhesive media. One skilled in the art of adhesives formulations readily grasps the similarities to formulation of polymer- and rubber-modified bitumen adhesives for roofing and road construction applications and the formulations of polymer- and rubber-modified adhesives for other common industrial applications (such as laminate countertop and flooring manufacture, laminated wood products manufacture, metals bonding, plastics bonding, and the bonding of other materials).

While the disclosure provides adhesive compositions based on many adhesive media, specific attention is given to adhesive compositions wherein the primary adhesive medium is bitumen. Additionally, special attention is given to formulations wherein the polymeric substances and materials comprise elastomeric styrene-butadiene block polymers and recycled tire rubber, and the surface active agents are amides derivatives of C6-C22 fatty acids. One skilled in the art of adhesives formulations will readily ascertain that the compositions described herein are suitable for use in a variety of applications including modified bitumen for paving, roofing, and other construction or industrial applications, including production of laminated countertops, flooring manufacture, laminated wood product manufacture, and bonding, e.g., wood bonding, metal bonding, and plastics bonding.

As described herein, the degree of dispersion of the composite polymer composition in the adhesive media can be “tuned” over a range of dispersed states from particulate to sol to gel.

The disclosure will also involve the novel element of surfactant-mediated control of the degree of dispersion of the polymeric material so that the polymeric materials in the finished adhesive composition exist in a controlled degree of dispersion ranging from particulate to sol to gel. We can measure the relative levels of particulate and sol/gel content in bitumen treated with the surfactant-treated polymeric materials of the present invention.

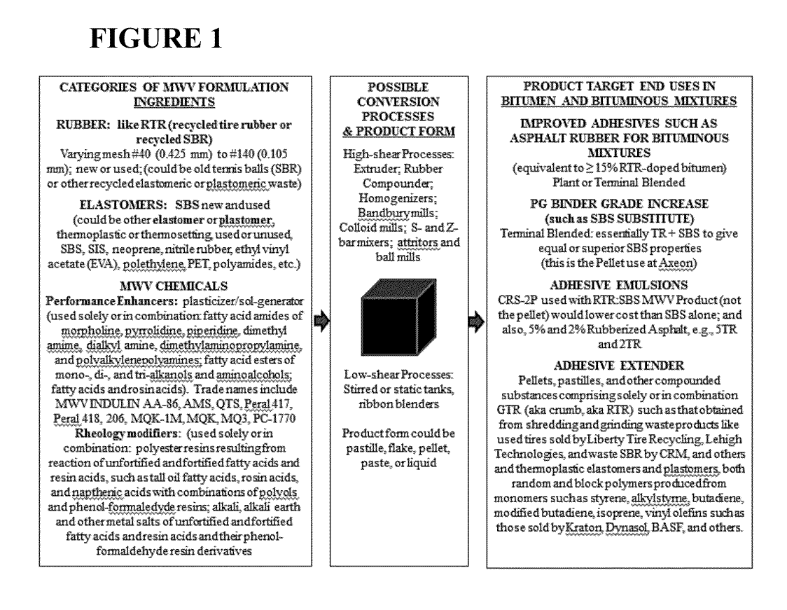

FIG. 1 highlights formulation ingredients, processing and conversion operations, and end-use applications encompassed by the present description. In particular, the figure exemplifies formulation ingredients and processing operations related to adhesives applications involving bituminous paving compositions for road construction and road maintenance.

As discussed, there are two key challenges to producing settlement-resistant, storage-stable compositions comprising liquid or particulate polymeric materials in adhesive media such as bitumen for roads and roofing or laminating adhesives for other engineering materials. First, using cost-effective formulation variables (Fi) and process conditions (Pi), the molecular species and functional groups comprising the liquid or particulate polymeric material must be wetted by molecular species (or certain chemical functionality of the molecular species) comprising the adhesive media. The thermodynamic principles governing wetting phenomena (adsorption and absorption) are assumed to be understood by those skilled, including the laws which relate the ionic, dispersive, dipolar, and hydrogen bonding characteristics of molecular species to their interaction potentials (interaction energies). Second, a portion of the polymeric material must be subsumed by molecular species comprising the adhesive media. The resulting partially or fully subsumed polymeric material is thereby rendered dispersed and/or solvated by the molecular species in the adhesive media. The partial or full dispersion or solvation of the liquid or polymeric material reduces its size, r, or effective radius. Similarly, partial or full dispersion or solvation of the polymeric material reduces differences in densities between the polymer and the adhesive media, (ρ_{polymer}−ρ_{adhesive}) to at or near zero. Similarly, the partial or full dispersion or solvation of the polymeric material may result in network entanglement of the polymer chains, leading to an increase in the viscosity, 11, of the resulting adhesive composition. The degree of these changes determines the settle-resistance of the adhesive composition according to Stokes law of settlement; wherein the gravitational constant is g, settlement velocity=[g*r2*(ρ_{polymer}−ρ_{adhesive})/18η].

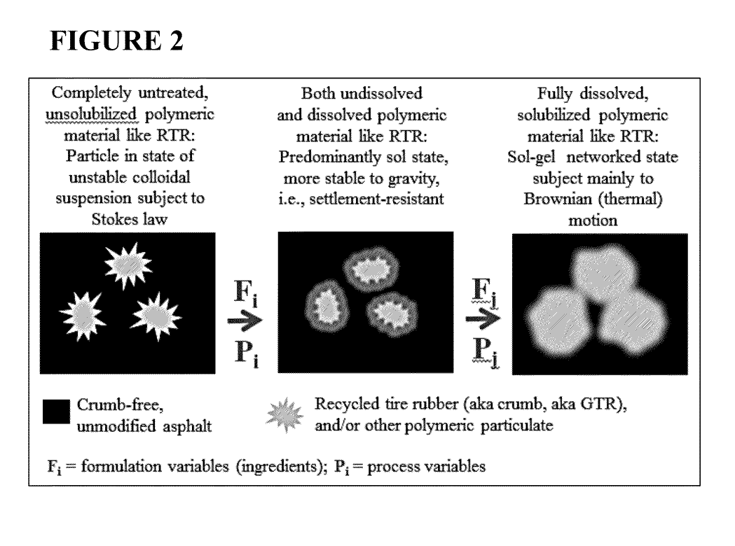

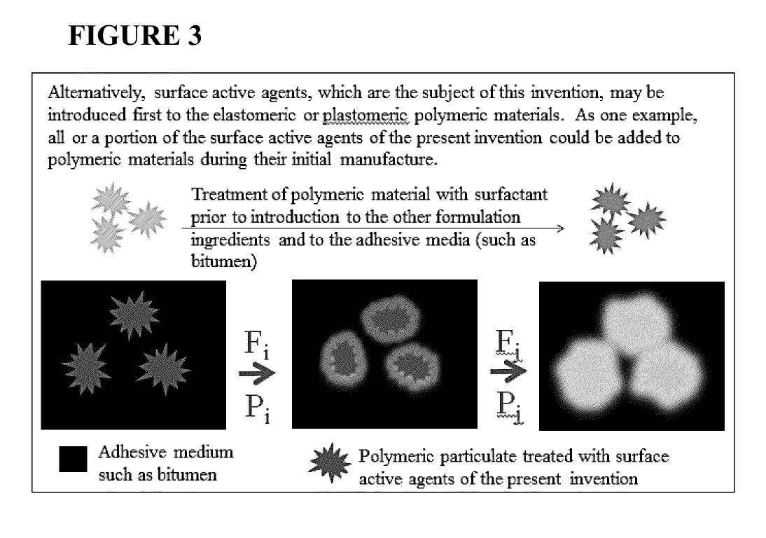

FIG. 2 illustrates dispersion states of polymeric material possible according to the compositions and methods as described herein. In particular, the figure depicts particulate, sol, and gel dispersion states. In certain aspects as described herein, as depicted in FIG. 3, the polymeric material may be treated with surfactants and additives taught in the present invention prior to introduction of the surfactant-treated polymeric material to the adhesive medium.

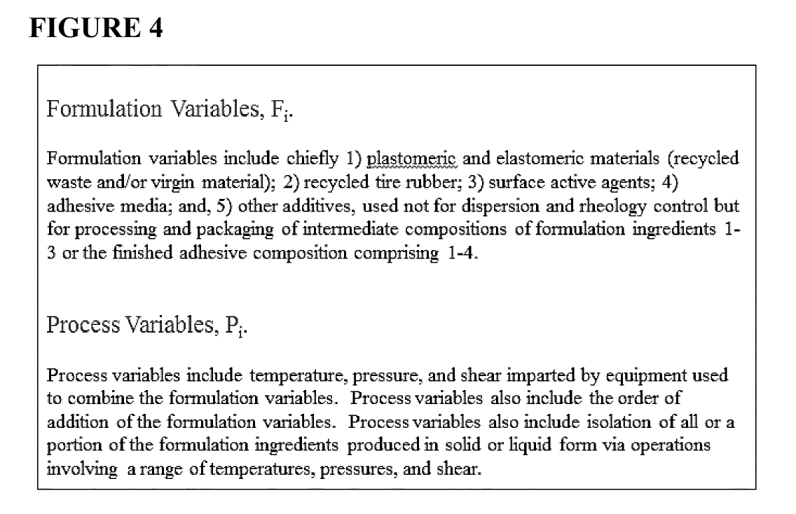

FIG. 4 depicts exemplary formulation variables and process conditions, which are described herein. The formulation and manufacturing process can be varied in a number of ways which are encompassed by the present description.

Without being bound by any particular theory, the inventors hypothesize that the surfactant is effective for dispersing the SBS and/or rubber because the polymer chains in the elastomer (SBS and rubber) are moved apart by the adsorption and-then absorption of surfactant molecules. For example, when 1 part of SBS is combined with 6 parts of rosin pentaerythritol ester (a precursor of Westrez 5101 rheology modifier), it is observed that the polymer is swollen by the ester. Again, without being limited by any particular theory, the ester is likely partially penetrating in between some SBS chains. It is not, however, a solution. In contrast, when the TOFA morpholine amide is combined with SBS at the same 6:1 ratio, the polymer is much more fully subsumed (than with the ester). That is a larger number of polymer chains are moved apart by the absorbing morpholine amide. With enough morpholine amide it might be possible to “solvate” the entire polymer. But, according to the present description, this is controlled so that viscosity (stiffness properties, G*/sin delta) is maintained within specification.

Methods

In another aspect, the description provides processes for preparing a composite polymer material as described herein comprising the steps of, admixing the various components or ingredients for the composite polymer material by stepwise addition of all or a portion of the surface active agents to the polymer materials during their initial manufacture. In still another embodiment, the description provides a process for preparing a composite polymer material as described herein comprising the steps of, applying or treating the elastomeric material and/or plastomeric material or combination thereof with all or some of the surface active agent(s) during comminution or trituration operations.

In another aspect, the description provides methods of making a composite polymer material as described herein comprising the steps of: a) admixing and/or dispersing at least one of an elastomer, a plastomer or a combination thereof in an additive, e.g., including a surfactant, with heat; b) mixing the composition from (a) with crumb rubber forming a homogenized mixture, wherein the additive acts as a glue to hold together the elastomer and/or plastomer, and wherein the dispersed elastomer and/or plastomer mixture forms a dough; c) shaping or processing the dough from (b) into a suitable form, e.g., pellet, flake, powder, granule, pastille, extrudate, and/or block mass of any suitable physical dimension, while still warm; and optionally d) cooling the pellets from (c). In certain embodiments, the process includes an additional step of combining the composite polymer material from step (c) with an adhesive medium to form a modified-adhesive composition.

In still another aspect, the description provides methods of making a modified adhesive formulation comprising admixing a composite polymeric material as described herein, and an adhesive material, e.g., asphalt or a laminating adhesive. In a preferred embodiment, the description provides a method of making a modified asphalt formulation comprising admixing asphalt and an effective amount of a composite polymeric material as described herein, wherein the composite polymeric material prevents or delays the phase separation of the asphalt from the composite polymer material.

In an additional aspect, the description provides processes for preparing a composite polymer material-modified adhesive comprising admixing the ingredients of a composite polymer material formulation as described herein with the final adhesive composition using, e.g., conventional mixing in thermostatically-controlled, low-shear devices like Hobart mixers and stirred-tank reactors to thermostatically-controlled, high-shear mixing equipment such as Siefer and Supraton colloid mills, Ross and Silverson dispersers, attritor mills, and in S- and Z-bar mixers, as well as in extruders. In certain embodiments, the various components or ingredients for the composite polymer material are combined by stepwise addition of all or a portion of the surface active agents to the polymer materials during their initial manufacture, followed by admixing of the surfactant-treated polymeric material to the other formulation ingredients and an adhesive material.

In certain additional embodiments, the description provides processes for preparing a composite polymer material-modified adhesive comprising the steps of applying or treating an elastomeric material and/or plastomeric material or combination thereof with at least one surface active agent during comminution or trituration operations, and admixing the surfactant-treated polymeric material (i.e., composite polymer material as described herein) to the adhesive media and other formulation ingredients comprising the final adhesive composition. Similarly, processes are also described wherein combinations of all or portions of the formulations ingredients, such as the polymeric substances and surface active agents, are mixed together in one of the aforementioned devices and then isolated in solid or liquid form, followed by controlled dispersion in the adhesive media to produce the final adhesive composition.

In certain additional embodiments, the description provides processes for preparing a composite polymer material-modified adhesive comprising the steps of admixing the ingredients of the composite polymer material formulation, isolating the material in solid or liquid form, and dispersing in the adhesive media to product the final adhesive composition.

As the skilled artisan would ascertain, the composite polymer material as described herein can be in any suitable form that is known and used for combining with an adhesive material, e.g., asphalt or bitumen, such as powders, granules, pastilles, extrudates, and block masses of varying physical dimension.

In an additional aspect, the description provides finished adhesive compositions comprising polymeric plastomers and elastomers, recycled tire rubber, surface active agents that impart dispersion and rheological control, and bitumen. These specific, novel bitumen-based adhesive compositions, characterized by uniquely controlled dispersion and rheological properties, are intended for use applications to which bitumen is commonly applied. These applications include chiefly water impermeabilization, roof and pavement maintainance, and roof and pavement rehabilitation and construction.

In one aspect, the present invention relates to a method for preparing a rubber-modified asphalt cement composition, comprising: contacting asphalt with rubber granules to form a mixture; heating the mixture; and passing the heated mixture through at least one high shear mixer. In another aspect, the present invention relates to a method for preparing a rubber-modified asphalt cement composition, comprising: contacting asphalt with rubber granules to form a mixture; heating the mixture to a temperature of at least about 100° F.; and passing the heated mixture through at least one high shear mixer for greater than 30 minutes.

In another aspect, the present description provides methods for high-throughput preparation of a rubber-modified asphalt cement composition, comprising: contacting asphalt with rubber granules and/or a composite polymer material as described herein to form a mixture; heating the mixture; and passing the heated mixture through at least one high shear mixer; and wherein the method is performed in less than 24 hours.

In another aspect, the present invention relates to a rubber-modified asphalt cement composition prepared by: contacting asphalt with rubber granules to form a mixture; heating the mixture; and passing the heated mixture through at least one high shear mixer.

A rubber-modified asphalt cement (RMAC) having superior properties can be prepared in any suitable manner by mixing, blending, combining, and/or contacting asphalt and composite polymer material using a system or method that comprises at least one high shear mixer or mill, under suitable conditions (e.g., a mixture temperature maintained at greater than about 100° F.) and for a suitable duration to cause a substantial amount or even all of the composite polymer material particles or granules to be dispersed, suspended, liquefied or otherwise subsumed, incorporated, and/or integrated into the asphalt base or medium without any significant and/or substantial degradation and/or destruction of the base asphalt occurring.

In another embodiment, for example, the composite polymer material and asphalt are mixed without air blowing, jet spray agitation, oxidation, and/or or substantial distillation of the asphalt component. In some embodiments, a high throughput system and method are provided for fast, efficient, reduced cost production of fully integrated rubber-modified asphalt cement.

### EXAMPLES

### Example 1

### An Isolable Intermediate Comprising Plastomeric and/or Elastomeric Polymeric Materials, Surfactants, and Processing Additives

An isolable blend of elastomer and RTR using a fatty amidopolyamine is described. This isolable product is hereforth referred to as a “composite polymer material.” The composite polymer material is used to produce improved, polymer-modified bitumen. In this exemplary embodiment, the composite comprises an elastomer/RTR blend of styrene-butadiene-styrene (SBS) and recycled tire rubber (RTR), both commonly used in asphalt modification.

Typically, asphalt is either modified using SBS alone or using RTR alone. SBS is more expensive than RTR, and so, SBS is being replaced with RTR to offset cost. Also, in current industrial applications, SBS and RTR are added to the bitumen individually and separately. Settlement instability is a recurring problem for bitumen producers when they add SBS and RTR or RTR alone. Different bitumen producers have tried producing dispersion of SBS and RTR with varying degrees of success. Again, the chief problem with substituting SBS with RTR is poor storage stability of the bitumen due to the settlement effects on the RTR particles induced by gravitational forces. Thus, the RTR particles tend to settle in bitumen. Handling RTR in large quantities at bitumen facilities like petrochemical refineries presents risks due to the fire hazard presented by the RTR powder.

In one exemplary process, varying amounts of SBS polymer and RTR are treated with surfactant additives using slight heat (thermal) and mechanical energy input to create an isolable surfactant-modified composition of matter comprising dispersed SBS and RTR. The surfactant-mediated, dispersed mixes of surfactant treated SBS and RTR (i.e., composite polymer material) appear as a uniform mass of homogenized SBS and RTR. While still warm, this mass or dough can be shaped with conventional extrusion or pelletization or pastillization equipment into handleable forms. In one embodiment, the homogenized SBS/RTR composite polymer material hardens and the pellets retain their shape.

In an exemplary embodiment, a composite polymer material was prepared comprising about 55% GTR, about 27% SBS and about 18% additives (including surfactant). These isolable materials (e.g., pellets) are roughly the same size and shape of typical SBS polymer supplied to the bitumen industry. Additionally, the isolable and can be added to the asphalt just like SBS. Surprisingly and unexpectedly, the composite polymer material demonstrated the novel feature of being more readily and efficiently dispersable in bitumen vis-à-vis SBS or RTR alone.

When bitumen is modified with the composite polymer material as described herein (pellets, pastilles, etc.), it has been observed that the composite polymer material is more readily dispersed in the bitumen compared to typical SBS, RTR, or blends thereof. It is also noticed that, compared to typical SBS polymer alone, less quantity of the composite polymer material is required to cause the same stiffening effect in asphalt. Initial tests suggest a dosage for the composite polymer material as described herein of approximately 0.1% to less than 3% by weight, preferably approximately 1% to about 2% by weight of asphalt provides results comparable to that observed with to 3-4% or more of typical polymers. Additionally, due to the interaction of the surfactant additives in dispersion of the SBS and the RTR during the mixing process, the storage stability (separation resistance) of the modified bitumen is vastly improved above bitumen modified via conventional methods with SBS, RTR, and combinations thereof. Specifically, the composite polymer material yields modified bitumen showing less than 5% phase separation in standardized test procedures.

When the same raw ingredients were added to the asphalt (individually, without making a pellet) the storage stability was not satisfactory, suggesting that the mechanical energy and interaction between the additives and other ingredients during the pellet making process improves the way in which the polymer and GTR interact with the asphalt and stay suspended. This also highlights the novel and unexpected finding that the surfactant-mediated dispersion of the polymeric materials (SBS and RTR) of the present description yields an improved modified adhesive bitumen composition.

The surfactants of the present invention have been demonstrated to exhibit the unique ability to disperse polymeric substrates.

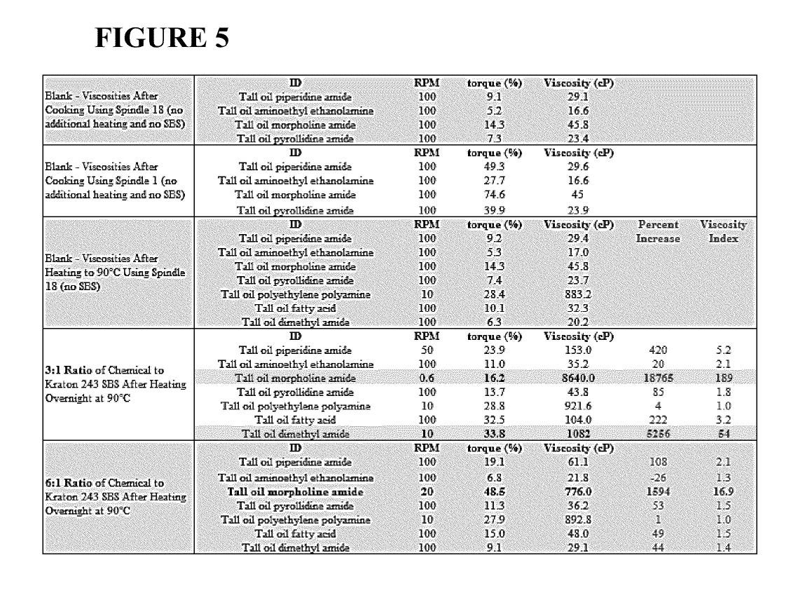

FIG. 5 illustrates this capability. One can see that TDMA (a dimethyl amine amide of tall oil fatty acid) gave a viscosity index of 54. By contrast, an exemplary material as described herein, labelled 8986-55D gave a viscosity index of 189. That is, the 8986-55D was 3 times more effective at dispersing or solubilizing the radial styrene-butadiene-styrene polymer, Kraton 243.

Without being bound by any particular theory, the inventors hypothesize that the surfactant is effective for dispersing the SBS and/or rubber because the polymer chains in the elastomer (SBS and rubber) are moved apart by the adsorption and-then absorption of surfactant molecules. For example, when 1 part of SBS is combined with 6 parts of rosin pentaerythritol ester (a precursor of Westrez 5101 rheology modifier), it is observed that the polymer is swollen by the ester. Again, without being limited by any particular theory, the ester is likely partially penetrating in between some SBS chains. It is not, however, a solution. In contrast, when the TOFA morpholine amide is combined with SBS at the same 6:1 ratio, the polymer is much more fully subsumed (than with the ester). That is a larger number of polymer chains are moved apart by the absorbing morpholine amide. With enough morpholine amide it might be possible to “solvate” the entire polymer. However, according to the present description, this is controlled so that viscoelastic properties (stiffness properties, G*/sin delta) are maintained within specification.

FIG. 5 provides experimental viscosity results for a number of exemplary formulations as described herein. The data in FIG. 5 were generated in experiments wherein a linear, block SBS polymer (Kraton 243) and a radial, block SBS polymer (Kraton 245) were mixed in ratios 1:3 and 1:6 with various surface active additives as taught herein. The polymer-additive mixtures were allowed to stand overnight in a forced draft oven at 90° C. No mechanical shear was used in the process which generated the results in FIG. 5. The additive in FIG. 5 labelled 8986-55D is a morpholine amide of tall oil fatty acid as described herein. Compared to the other additives, it significantly wets (adsorbed and absorbed into) the Kraton 243 and Kraton 245 polymers and suspended the so-dispersed polymer into the supernatant liquid. The viscosity of the supernatant liquid in the mixtures containing 8986-55D increased over 18,700 percent compared to the control, which was not exposed to polymer. Similar analysis shows the product labelled TDMA wet and suspended a sufficient amount of the Kraton 243 that the viscosity of the supernatant increased over 5200 percent compared to the control TDMA sample, which was not exposed to polymer.

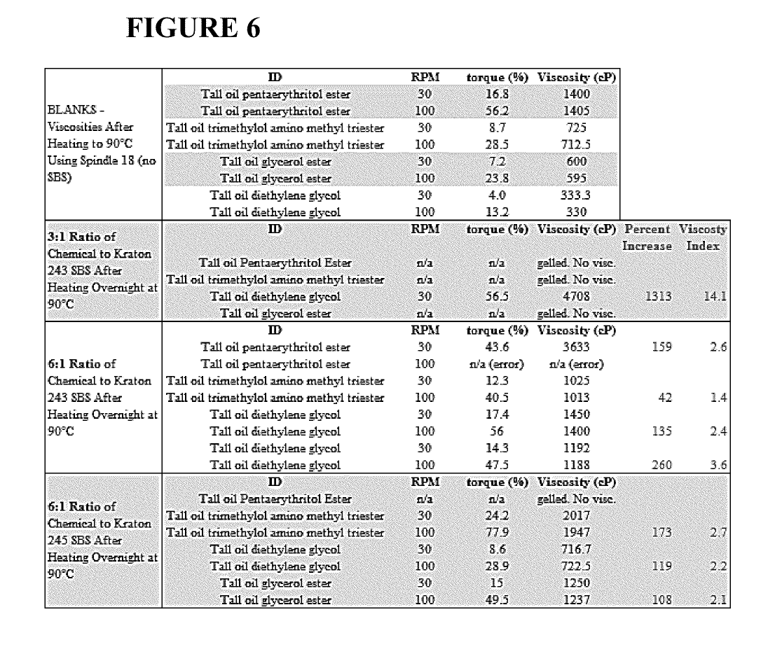

FIG. 6 shows surfactant-mediated control of the degree of dispersion of the polymeric material so that the polymeric materials in the finished adhesive composition exist in a controlled degree of dispersion ranging from particulate to sol to gel. Very low viscosity indices are measured for the surfactants. The relative levels of particulate and sol/gel content in bitumen treated with the surfactant-treated polymeric materials of the present invention can be accurately measured. The figure demonstrates that many conventional surfactants are not as effective as 8986-55D.

FIG. 6 shows results obtained from an experiment similar to that which generated the results in FIG. 5. Linear, block SBS polymer (Kraton 243) and a radial, block SBS polymer (Kraton 245) were mixed individually in ratios 1:3 and 1:6 with various surface active additives taught in the present invention. The viscosity of the supernatant liquid was measured before conditioning in the oven while exposed to the polymer sample and after conditioning in the oven in the presence of the polymer. The data in the set of mixtures based on the 6:1 ratio of additive and Kraton 243 can be examined to show the differences in the power of the various additives to wet and subsume the polymer. In that data set, the viscosity of the additive, Polyfac TE-319, increased over 900% upon exposure overnight to the Kraton 243 linear, block SBS polymer.

### Example 2

### Exemplary Process for Making Rubber-Modified Bitumen as Described Herein

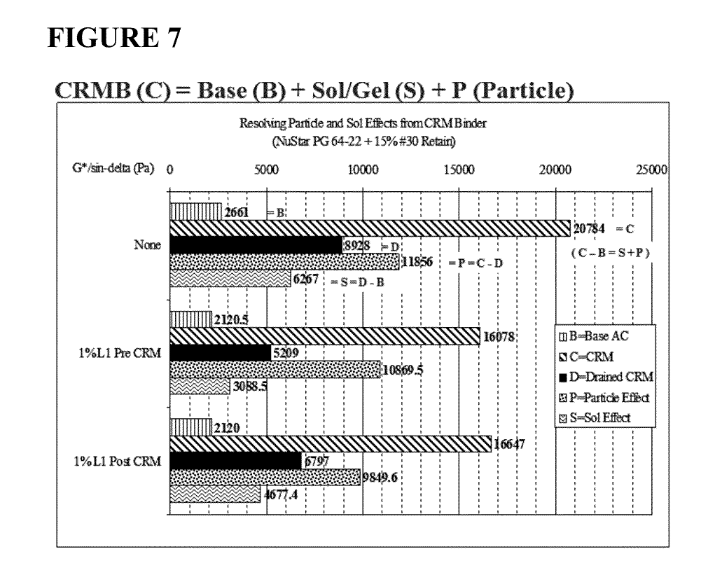

As described herein, the compositions of the invention allow one to modulate or control the degree of dispersion and/or solvation of liquid or solid polymeric materials by treatment (via various processes) with additives and surfactants. FIG. 7 shows the results of measurement of the degree of transformation of solid, recycled tire rubber elastomer from particulate matter to a sol-gel state dispersed in bitumen. The method involved adding an additive surfactant as described herein to a first batch of bitumen. The surfactant-treated bitumen was then treated with 15% w/w of a second bitumen having a single-size, one-mm recycled tire rubber material. The bitumen stiffness prior to treatment with the rubber particles was measured. This stiffness value is labelled B (for the Base bitumen). After treatment with the rubber material, the rubber-modified bitumen stiffness was measured. This stiffness value is labelled C (for the Crumb-rubber modified bitumen). The rubber-modified bitumen was sieved through a #100 sieve. The stiffness of the rubber-modified bitumen, which drained through the sieve was measured. This stiffness value is labelled D (for the Drained bitumen). The extent to which a rubber particulate remains unsolubilized in the crumb is calculated as P=C−D. The extent to which the original particulate is dispersed into a sol is given by S=D−B. FIG. 7 shows the effects of a modifying the crumb rubber-treated asphalt with a simple tall oil fatty acid mixture, labelled L1, at 1% by weight of the crumb rubber modified bitumen. Thus, the total stiffness of a modified bitumen is the sum of the stiffness values of the base plus the P value and the S value, that is, C=B+P+S.

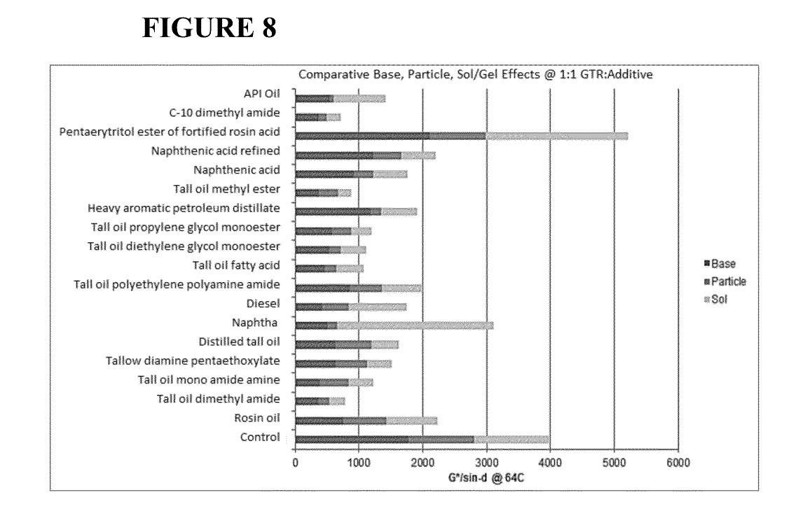

FIG. 8 shows examples of values for B, P, and S using many different additives at a dosage of 1.0% by weight of the bitumen.

### Example 3

### Exemplary Process for Producing Composite Polymer Material as Described Herein

The process involves the following general steps: a) dispersing the SBS polymer in the additives, including a surfactant, with heat and mechanical mixing; b) mixing the composition from (a) with the RTR forming a homogenized mixture. The rubber component can be: e.g., new or recycled, RTR; mesh #40-140. The SBS/additives mixture acts as a glue to hold together the RTR, and wherein the dispersed SBS/RTR mixture forms a dough; c) shaping the dough from (b) into smaller pellets while still warm; d) cooling the pellets from (c); and e) admixing the pellets from (d) to asphalt. As the mass cools, the dispersed SBS tends to harden and the pellets retain their shape. The composite polymer contains about 55% RTR, about 27% SBS, and about 18% additives, including a surfactant. These pellets are roughly the same size and shape of typical SBS polymer and can be added to the asphalt just like SBS. This eliminates the problems of handling dry powdered RTR at the asphalt plants.

The elastomer component can be: e.g., SBS, SIS, neoprene, nitrile, polyethylene, PET, etc.; new or used. The additive can include one or more of:

i) a “rheology modifier” (e.g., Rosin, Gum Rosin, Rosin Acid, and Rosin Derivatives, and preferably esters of fortified rosin acid or combination thereof (“Fortified” means rosin acid reacted with maleic anhydride or fumaric acid or acrylic acid.);

ii) a “performance enhancer” (i.e., surfactant)

a. Tall oil, an amide derivative of a C6-C22 fatty acid, an amidated tall oil, fatty acid amide, tall oil fatty acid amide, fatty acid amide of morpholine, fatty acid amide of dimethyl amine, fortified tall oil fatty acid amide, tall oily fatty acid amindoamine or the like, e.g., polyethylene polyamine derivatives of TOFA or other fatty acid, lipid, phospholipic, e.g., phosphotidylcholine or lecithin, or a combination thereof.

b. Other non-TOFA fatty acid derivatives coming from other natural sources, other than the pine tree; natural fats, natural triglycerides, natural oils or combination thereof

An exemplary formulation is as follows:

| Name/Catalog No. | Type | Mass | % |
|---|---|---|---|
| D0243 | SBS polymer | 175 | 26.7 |
| CRM #50 | RTR | 350 | 53.3 |
| PC-1770 | performance enhancer | 93.75 | 14.3 |
| WESTREZ 5101 | rheology modifier | 31.25 | 4.8 |
| Lime | used post-pelletization | 6.5 | 1.0 |
| | to prevent | | |
| | agglomerization | | |

When asphalt is modified with the composite polymer pellets, it has been observed that dispersing the SBS in the additives allows the SBS polymer to more readily disperse in the asphalt compared to typical SBS. It is also noticed that compared to typical SBS polymer, less quantity of composite polymer is required to cause the same stiffening effect in asphalt.

### Example 4

### The Use/Preparation of the Morpholine Amide of Fatty Acids

Also described herein are methods for synthesis of amides of fatty acids and esters, which can be used as an ingredient in the preparation of the composite polymer materials as described herein that deliver the targeted control of the dispersion and rheological properties of the modified adhesive, e.g., asphalt or bitumen.

In general it can be said that the usual methods possess at least one of three serious drawbacks. Either the methods require long process (reaction) times, the methods give low percentage yields, or the methods require the synthesis of an expensive intermediate compounds or the use of highly toxic gases (such as dimethyl amine). For example, the common method of synthesis is to allow ammonia and fatty acid to react under anhydrous conditions. This permits almost complete conversion, but requires a reaction time of as much as several days. Similarly, other methods have used expensive intermediates such as acid halides, which react with ammonia to form corrosive inorganic acids as well as the desired amide.

The present description provides a method of synthesis which will give a high percentage yield of amide with a short reaction time, and does not require expensive intermediate compounds. The methods described herein allows production of surfactants with performance characteristics in asphaltene dispersion and polymer solubilization superior to those imparted by N,N-dimethylamide of TOFA, and is superior in that pressurized reaction vessels are not necessary, handling of highly poisonous dialkyl amines is obviated, no purification step (distillation and off-gas removal) is needed, no “de-watering” or “de-gassing” is needed, and no expensive catalysts are needed.

### Example 5

### Exemplary Surfactant-Dispersed Elastomer Formulation as Described Herein

An exemplary surfactant-dispersed elastomer formulation was prepared by adding #50-mesh recycled tire rubber (crumb rubber), styrene-butadiene-styrene (SBS) block polymer (radial, Kraton D245) in ratios of roughly 1:1 and 2:1, and a fortified rosin ester rheology modifier to an S-bar mixer. These three materials were commixed while heat was applied to the S-bar mixer. When the temperature reached about 100°-140° C., the surfactant package was added. (The surfactant package comprised one or more surfactants.) The surfactant-treated mixture was stirred for another 2-60 minutes to complete the commixing. The resulting surfactant-dispersed elastomeric preparation was pelletized by extrusion through a dye with opening diameters ranging from about 2 mm to about 10 mm. The resulting pellets were dusted with 1% hydrated lime w/w pellet. Pellets made in this way were dispersed in bitumen by adding with stirring to heated bitumen, followed by stirring for prolonged periods. Pellets treated in this manner disperse more rapidly in bitumen and at lower temperatures than the SBS itself or crumb rubber itself. Standard rheology tests were performed on the resulting pellets after dispersion into bitumen. Table I shows the results of tests of pellets made in the above manner and coded 19A, 21B, 23A, and 24A. One skilled in the art of polymer-modified bitumen will recognize that all properties are within or exceed specifications for a PG 76-22 bitumen using the surfactant-dispersed rubber-SBS preparations. Additionally, one skilled in the art will observe improvements in the Cigar Tube Storage Stability Test realized by inclusion in the surfactant package either C-18 amide of dimethyl amine or C-18 amide of morpholine. The stability is improved from 0.9% to 0.3%. Moreover, the stability improvement is maintained when the ratio of crumb rubber increases from 1:1 to 2:1 (see 21B and 24A versus 23A).

TABLE I
Results of tests of pellets made in accordance with Example 5.

| | | Experiment Code | | | |
|---|---|---|---|---|---|
| | | 19A | 21B | 23A | 24A |
| | | Component Concentration, % by | | | |
| Component in Surfactant-Treated Elastomer Preparation | | Weight of PG 70-22 Bitumen | | | |
| Recycled Tire Rubber (#50-mesh Crumb) | | 1.26 | 1.6 | 1.6 | 1.26 |
| Radial SBS Block Polymer (Kraton D245) | | 1.14 | 0.8 | 0.8 | 1.14 |
| C-18 Amide of polyalkylene polyamine | | 0.23 | 0.23 | 0.43 | 0.34 |
| C-18 Amide of dimethyl amine | | 0.2 | 0.2 | 0 | 0 |
| C-18 Amide of morpholine | | 0 | 0 | 0 | 0.09 |
| Fortified rosin polyester resin | | 0.14 | 0.14 | 0.14 | 0.14 |
| Hydrated Lime | | 0.03 | 0.03 | 0.03 | 0.03 |
| Total components, % w/w bitumen | | 3.0 | 3.0 | 3.0 | 3.0 |
| Original Grade | Pass Fail Temp (° C.) | 77.5 | 79.0 | 79.8 | 77.8 |
| Rolling Thin Film | Pass Fail Temp (° C.) | | | | |
| Oven Test | | 77.2 | 77.4 | 79.2 | 77.9 |
| Multi-Stress Creep | Jnr 3.2 kPa @ 64 c | 0.6 | 0.6 | 0.5 | 0.6 |
| Recovery Test | AVG % recovery @ 3.2 Pa | 20.5 | 18.7 | 23.9 | 21.6 |
| Cigar Tube Storage | Difference between Failure | 0.7% | 0.3% | 0.9% | 0.3% |
| Stability Test | Temperature, Top and Bottom | | | | |

### Example 6

### Exemplary Surfactant-Dispersed Elastomer Formulation as Described Herein

Surfactant-dispersed elastomer preparations of the present invention were prepared by adding #50-mesh recycled tire rubber (crumb rubber), styrene-butadiene-styrene (SBS) block polymer (linear, Kraton D243), and a fortified rosin ester rheology modifier to an S-bar mixer. The three materials were commixed while heat was applied to the S-bar mixer. When the temperature reached about 100°-140° C., the surfactant package was added. The mixture was stirred for another 2-60 minutes to complete the commixing. The mass was pelletized by extrusion through a dye with opening diameters ranging from 2 mm to 10 mm. The resulting pellets were dusted with 1% lime w/w pellet. Pellets made in this way were dispersed in bitumen by adding with stirring to heated bitumen, followed by stirring for prolonged periods. Pellets treated in this manner dispersed more rapidly in bitumen and at lower temperatures than the SBS itself or crumb rubber itself. Standard rheology tests were performed on the resulting pellets after dispersion into bitumen. Table I shows the results of tests of pellets made in the above manner and coded 35A and 36B. One skilled in the art of polymer-modified bitumen will recognize that all properties are within or exceed specifications for a PG 76-22 bitumen using the surfactant-dispersed rubber-SBS preparations.

TABLE II
Results of tests of pellets made in accordance with Example 6.

| | | Experiment Code | | | | | |
|---|---|---|---|---|---|---|---|
| | | 36B | 35A | 35A | 35A | 35A | 35A |
| Component in Surfactant-Treated | | Component Concentration, | | | | | |
| Elastomer Preparation | | % by Weight of PG 70-22 Bitumen | | | | | |
| #50 Recycled Tire Rubber (CRM) | | 0.53 | 0.53 | 1.6 | 2.67 | 3.73 | 4.8 |
| Linear SBS Polymer (Kraton D243) | | 0.27 | 0.27 | 0.8 | 1.33 | 1.87 | 2.4 |
| C-18 Amide of polyalkylene polyamine | | 0.11 | 1.14 | 0.43 | 0.71 | 1 | 1.29 |
| C-18 Amide of morpholine | | 0.03 | 0 | 0 | 0 | 0 | 0 |
| Fortified rosin polyester resin | | 0.05 | 0.05 | 0.14 | 0.23 | 0.327 | 0.42 |
| Lime | | 0.01 | 0.01 | 0.03 | 0.05 | 0.07 | 0.09 |
| Total components, % w/w bitumen | | 1.0 | 1.0 | 3.0 | 5.0 | 7.0 | 9.0 |
| Original Grade | Pass Fail Temp (° C.) | 77.6 | 78.2 | 80.9 | 83.9 | 85.9 | 88.2 |
| | G*/sinδ, kPa at 82° C. | 0.61 | 0.65 | 0.88 | 1.22 | 1.51 | 2.00 |
| | G*/sinδ, kPa at 76° C. | 1.19 | 1.28 | 1.68 | 2.26 | 2.86 | not run |
| | G*/sinδ, kPa at 64° C. | 5.09 | 5.47 | 6.68 | 8.87 | 11.15 | 15.65 |
| Multiple Stress Creep | Jnr 0.1 kPa @ 64 c. | 0.46 | 0.43 | 0.37 | 0.23 | 0.13 | 0.07 |
| Recovery Test | Jnr 3.2 kPa @ 64 c. | 0.51 | 0.47 | 0.42 | 0.26 | 0.15 | 0.09 |
| | AVG % recovery @ 0.1 kPa | 24% | 24% | 32% | 44% | 57% | 67% |
| | AVG % recovery @ 3.2 Pa | 17% | 18% | 25% | 37% | 52% | 63% |
| Rolling Thin Film | Pass Fail Temp (° C.) | 78.8 | 79.3 | 79.8 | 82.6 | 85.6 | 87.4 |
| Oven Test | G*/sinδ, kPa at 82° C. | 1.53 | 1.63 | 1.73 | 2.33 | 3.10 | 3.85 |
| | G*/sinδ, kPa at 76° C. | 3.03 | 3.22 | 3.37 | not run | not run | not run |
| | G*/sinδ, kPa at 64° C. | 13.0 | 13.8 | 13.8 | 17.0 | 20.5 | 25.2 |
| Cigar Tube Storage | Difference between Failure | not run | −0.1 | 1.2 | 4.6 | not run | not run |
| Stability Test | Temperature, Top and Bottom | | | | | | |

### Example 7

### Slow-Setting and Rapid-Setting Cationic Emulsions Made Tire Rubber Preparation Based on C-10 Dimethyl Amide

In an additional exemplary embodiment, surfactant-dispersed elastomer preparations were prepared by adding three parts of a C-10 fatty acid dimethyl amide to a mixing vessel and heating to approximately 100-150° C. A slotted mixing head attached to a Silverson high-shear mixer was immersed in the heated fatty acid amide. With the mixing rpm set to between about 1000-5000 rpm, roughly five parts of a roughly #100-mesh recycled tire rubber (approximately 0.100 mm top-size diameter) was incrementally added. Roughly eight parts of the resulting surfactant-dispersed rubber preparation was added to roughly 100 parts of a PG 64-22 paving-grade bitumen with stirring while the bitumen was heated to 125° C. After complete addition of the eight parts of surfactant-dispersed rubber preparation, the resulting rubberized bitumen was used to prepare cationic and anionic bitumen emulsions.

Cationic emulsions were successfully prepared using slow-setting, medium-setting, and rapid-setting emulsifiers. The slow- and rapid-setting emulsifiers are well known to one skilled in the art as work-horse commercial emulsifier products, respectively, MWV INDULIN W-5 and MWV INDULIN AA-86. All emulsions were prepared from aqueous emulsifier solutions adjusted with hydrochloric acid to pH 2.0-2.5. The content of INDULIN W-5 was 2.5% by weight of emulsion. The INDULIN AA-86 dosage was 0.40% by weight of emulsion. The solids content of the finished bitumen emulsions were roughly 60-68% by weight of the emulsion. Both the slow-set, W-5 emulsions, and the rapid-set, AA-86 emulsions were storage stable, yielding less than 0.

When no C-10 fatty acid dimethyl amide was used to disperse the recycled tire rubber, but rather the rubber was dispersed in asphalt using the Silverson milling procedure (1000-5000 rpm at 100-150° C.) the stable emulsions could not be produced.

### Example 8

### Cationic and Anionic Medium-Setting Emulsions Made with 105-Penetration Grade Bitumen Containing Surfactant-Dispersed Crumb Rubber (at Rubber Content of 5% w/w Bitumen)

A procedure similar to that used in Example 7 was followed to produce a surfactant-dispersed crumb-rubber preparation. This preparation was blended into a 105-penetration grade bitumen following the procedure described in Example 7. A medium-setting emulsifier, MWV Peral 414, a betaine amphoteric emulsifier, was used to produce the medium-set emulsion at both low and high pH (i.e., anionic pH). As a tie-point to the cationic emulsion in Example 7, another INDULIN AA-86 emulsion was prepared in this example. Table III shows the key formulation ingredients of the aqueous emulsifier solution, the pH, solids content of the finished emulsion, and the volume-average particle size and 90% particle size (properties both well-known to those skilled in the art of bitumen emulsion manufacture).

TABLE III
Results of tests of crumb-rubber preparation made
in accordance with Example 8.

| Emulsifier | Peral 414 | Peral 414 | AA-86 |
|---|---|---|---|
| Emulsifier, % by weight aqueous | 4.0 | 4.0 | 0.60 |
| emulsifier solution | | | |
| Aqueous emulsifier solution pH | 12 | 2 | 2 |
| at 25° C. | | | |
| % Solids in finished emulsion | 62.4 | 60.5 | 63.4 |
| Saybolt Furol viscosity at 50° C. | 180 | 78 | 200 |
| after one day storage, seconds | | | |
| Volume-average particle size, μm | 2.89 | 4.38 | 3.48 |
| <90% particle size, μm | 4.97 | 7.68 | 5.85 |
| Sieve after six days storage, % | 0.03 | 0.05 | 0.07 |

### Example 9

### Anionic Emulsion Prepared Using Bitumen Containing 5 wt % Elastomer Derived from Surfactant-Dispersed SBS-GTR Preparation

The surfactant-dispersed SBS-GTR preparation was obtained from a procedure similar to that in Examples 7 and 8. In this example, however, the finished preparation had a ratio of roughly 1:1:2 SBS:GTR:C-18 fatty acid dimethyl amide. The SBS used was a commercially available linear block polymer, Kraton D243. The GTR was used tire rubber of a #50 mesh. The anionic emulsion was obtained using the C-14 betaine amphoteric emulsifier Peral 414 at 4.0% in an aqueous solution adjusted to pH 12.0. The stable, low-sieve (0.05%) anionic bitumen emulsion was produced using a Charlotte G-5 mill (as in all the Examples of elastomerized emulsions above).

While preferred embodiments of the invention have been shown and described herein, it will be understood that such embodiments are provided by way of example only. Numerous variations, changes and substitutions will occur to those skilled in the art without departing from the spirit of the invention. Accordingly, it is intended that the appended claims cover all such variations as fall within the spirit and scope of the invention.

The contents of all references, patents, pending patent applications and published patents, cited throughout this application are hereby expressly incorporated by reference.

Those skilled in the art will recognize, or be able to ascertain using no more than routine experimentation, many equivalents to the specific embodiments of the invention described herein. Such equivalents are intended to be encompassed by the following claims. It is understood that the detailed examples and embodiments described herein are given by way of example for illustrative purposes only, and are in no way considered to be limiting to the invention. Various modifications or changes in light thereof will be suggested to persons skilled in the art and are included within the spirit and purview of this application and are considered within the scope of the appended claims. For example, the relative quantities of the ingredients may be varied to optimize the desired effects, additional ingredients may be added, and/or similar ingredients may be substituted for one or more of the ingredients described. Additional advantageous features and functionalities associated with the systems, methods, and processes of the present invention will be apparent from the appended claims. Moreover, those skilled in the art will recognize, or be able to ascertain using no more than routine experimentation, many equivalents to the specific embodiments of the invention described herein. Such equivalents are intended to be encompassed by the following claims.

1. A composite polymer composition comprising a plastomer material, elastomer material or combination thereof, and a surfactant.

2. The composite polymer of claim 1, wherein the plastomer or elastomer comprises a substituted or unsubstituted alkene or olefin, diene or diolefin, polyene, alkyne, substituted or unsubstituted polyethylene, oxidized polyethylene, ethylene vinyl acetate (EVA) polyethylene terephthalate (PET), styrene, polystyrene, crumb rubber, styrene-butadiene, or styrene-butadiene-styrene (SBS), styrene-isoprene-styrene (SIS), neoprene, nitrile or a combination thereof.

3. The composite polymer of claim 2, wherein the plastomer or elastomer comprises SBS, crumb rubber or a combination of both.

4. The composite polymer of claim 1, wherein the surfactant is at least one of an amide derivative of a C6-C22 fatty acid, an amidated tall oil, fatty acid amide, tall oil fatty acid (TOFA) amide, fortified tall oil fatty acid amide, tall oily fatty acid amindoamine, polyethylene polyamine derivative of TOFA, or a combination thereof.

5. The composite polymer of claim 1, wherein the composition further comprises at least one of a tall oil, tall oil fatty acid (TOFA), distilled tall oil, or TOFA derivative, ester of TOFA, methyl ester, alkyl ester, glycerol ester, penterythritol ester or combination thereof.

6. The composite polymer of claim 1, wherein the composition further comprises a rheology enhancer.

7. The composite polymer of claim 6, wherein the rheology enhancer comprises at least one of a tall oil derivative, rosin, gum rosin, rosin acid, rosin derivative, rosin oil, rosin ester, glycerol ester, penterythritol ester, ester of fortified rosin acid.

8. The composite polymer of claim 1, wherein the composition further comprises at least one of a natural fat, natural oil, fixed oil, vegetable oil, triglyceride, soybean oil, rapeseed oil, tallow oil, olive oil, essential oil or combination thereof.

9. The composite polymer of claim 1, wherein the composite polymer is in the form of a pellet, granule, flake or powder.

10. An adhesive formulation comprising an adhesive and a composite polymer material comprising a plastomer material, elastomer material or combination thereof, and a surfactant.

11. The adhesive formulation of claim 10, wherein the adhesive is an epoxy or an asphalt or bitumen.

12. The adhesive formulation of claim 11, wherein the plastomer or elastomer comprises a substituted or unsubstituted alkene or olefin, diene or diolefin, polyene, alkyne, substituted or unsubstituted polyethylene, ethylene vinyl acetate (EVA), oxidized polyethylene, polyethylene terephthalate (PET), styrene, polystyrene, crumb rubber, styrene-butadiene, or styrene-butadiene-styrene (SBS), styrene-isoprene-styrene (SIS), neoprene, nitrile or a combination thereof.

13. The adhesive formulation of claim 12, wherein the plastomer or elastomer comprises SBS, crumb rubber or a combination of both.

14. The adhesive formulation of claim 11, wherein the surfactant is at least one of an anionic surfactant, cationic surfactant, non-ionic surfactant, zwitterionic surfactant, an amide derivative of a C6-C22 fatty acid, an amidated tall oil, fatty acid amide, tall oil fatty acid (TOFA) amide, fortified tall oil fatty acid amide, tall oily fatty acid amindoamine, polyethylene polyamine derivative of TOFA, or a combination thereof.

15. The adhesive formulation of claim 11, wherein the composition further comprises at least one of a tall oil, tall oil fatty acid (TOFA), distilled tall oil, or TOFA derivative, ester of TOFA, methyl ester, alkyl ester, glycerol ester, penterythritol ester or combination thereof.

16. The adhesive formulation of claim 11, wherein the composition further comprises a rheology enhancer.

17. The adhesive formulation of claim 16, wherein the rheology enhancer comprises at least one of a tall oil derivative, rosin, gum rosin, rosin acid, rosin derivative, rosin oil, rosin ester, glycerol ester, penterythritol ester, ester of fortified rosin acid.

18. The adhesive formulation of claim 17, wherein the composition further comprises at least one of a natural fat, fatty acid, lipid, triglyceride, vegetable oil, essential oil or combination thereof.

19. The adhesive formulation of claim 10, wherein the composite polymer is in the form of a pellet, granule, flake or powder.

20. A modified asphalt composition comprising at least about 90% by weight of asphalt and from about 0.1% to about 10% by weight of a composite polymer material comprising from about 20% to about 95% by weight of at least one of an elastomer, a plastomer or a combination thereof, and from about 5% to about 80% by weight of an additive comprising at least one of a surfactant, an ester of fortified rosin acid, a polyethylene polyamine derivative (amides) of TOFA, a fatty acid, lipid, triglyceride, non-TOFA fatty acid derivative, natural fat, vegetable oil, essential oil or a combination thereof.

21. The modified asphalt composition of claim 20, comprising from about 50% to about 60% by weight of recycled rubber, and from about 20% to about 35% by weight SBS,

22. The modified asphalt formulation of claim 21, wherein the composite polymer is in the form of a pellet, granule, flake or powder.

23. A method of preparing the composite polymer of claim 1 comprising the steps of:
a) admixing and dispersing at least one of an elastomer, a plastomer or a combination thereof in an additive comprising at least one of a surfactant, an ester of fortified rosin acid, a polyethylene polyamine derivative (amides) of TOFA, a fatty acid, lipid, triglyceride, non-TOFA fatty acid derivative, natural fat, vegetable oil, essential oil or a combination thereof with heat;
b) mixing the composition from (a) with crumb rubber forming a homogenized mixture, wherein the additive acts as a glue to hold together the elastomer and/or plastomer, and wherein the dispersed elastomer and/or plastomer mixture forms a dough;
c) shaping the dough from (b) into smaller pellets while still warm; and
d) cooling the pellets from (c).

24. The method of claim 23, further including a step subsequent to step (d) comprising admixing the pellets from (d) with asphalt or bitumen.
